(19) United States
(12) Patent Application Publication
(10) Pub. No.: US 2016/0267493 A1
(43) Pub. Date: Sep. 15, 2016

(54) PRODUCT ANTI-COUNTERFEITING METHOD, APPARATUS AND SYSTEM

(71) Applicant: Tencent Technology (Shenzhen) Company Limited, Shenzhen (CN)

(72) Inventor: Wei LIU, Shenzhen (CN)

(21) Appl. No.: 15/158,386

(22) Filed: May 18, 2016

Related U.S. Application Data
(63) Continuation of application No. PCT/CN2014/093114, filed on Dec. 5, 2014.

(30) Foreign Application Priority Data
Dec. 31, 2013 (CN) 201310750316.8

(51) Int. Cl. G06Q 30/00; G06K 7/14; G06K 7/10; G06K 19/06

(52) U.S. Cl. CPC G06Q 30/0185; G06K 19/06037; G06K 7/1417; G06K 7/10861

(57) ABSTRACT

A computer-implemented method for product anti-counterfeiting is implemented at a computer server that is communicatively connected to a client terminal. The computer server receives a product authentication message from the client terminal and determines a total number of times that the product has been authenticated based, at least in part, on the product authentication message. When the total number of times is less than a predefined threshold level, the computer server generates a new product authentication record for the product from the product authentication message and identifies one or more existing product authentication records generated from past product authentication messages associated with the product. Based on comparing the new and existing product authentication records, the computer server generates and returns an authentication result message to the client terminal, the authentication result message including information derived from at least one existing product authentication record.

### RELATED APPLICATION

This application is a continuation application of PCT Patent Application No. PCT/CN2014/093114, entitled “PRODUCT ANTI-COUNTERFEITING METHOD, APPARATUS AND SYSTEM” filed on Dec. 5, 2014, which claims priority to Chinese Patent Application No. 201310750316.8, entitled “PRODUCT ANTI-COUNTERFEITING METHOD, APPARATUS AND SYSTEM” filed on Dec. 31, 2013, both of which are incorporated by reference in their entirety.

### TECHNICAL FIELD

The disclosed implementations relate generally to the field of product anti-counterfeiting technique, and in particular, to product anti-counterfeiting method, apparatus and system.

### BACKGROUND

With more and more counterfeit and shoddy products appearing in the market, how to help a user to determine the authenticity of a product has become one of the most important research subjects for the skilled in the field of anti-counterfeiting currently.

An existing product anti-counterfeiting method comprises: setting of an anti-counterfeiting label on the surface of the product by a manufacturer, wherein code of the product is set in the anti-counterfeiting label, meanwhile the coding of the product is stored in a server. When trying to determine the authenticity of the product, the user makes a call or goes online to enter a code of the product in the anti-counterfeiting label and sends the entered code to a server. Then the server detects whether there is stored a code being the same as the received code. When the detected result is that there is stored the same code, result information indicating that the product has been authenticated by an issuer is returned to the user. When the detected result is that the same code is not stored, result information indicating that the product is a counterfeiting one and not authenticated by the issuer is returned to the user.

Since the authenticity of the product can only be determined after a manual input of the product code by the user, and a failed authentication resulted from an enter error is likely to be incurred when the product code is long, the user may need to make repeated attempts to achieve this, so that in the above anti-counterfeiting method, the operation is too complicated for the user.

### SUMMARY

In accordance with some embodiments of the present application, the present application is implemented in a computer server that has one or more processors, memory and one or more modules, programs or sets of instructions stored in the memory for performing multiple functions and communicating with one or more client devices via a communication network (e.g., a PC, a tablet or a smartphone) that has one or more processors, memory and one or more modules, programs or sets of instructions stored in the memory for performing multiple functions. Instructions for performing these functions may be included in a computer program product configured for execution by one or more processors.

In accordance with some embodiments of the present application, a method for computer-implemented method for product anti-counterfeiting is performed at a computer server having one or more processors and memory for storing one or more program modules to be executed by the one or more processors. The method includes: receiving a product authentication message from a client terminal; determining a total number of times that the product has been authenticated based, at least in part, on the product authentication message; when the total number of times is less than a predefined threshold level: generating a new product authentication record for the product from the product authentication message; identifying one or more existing product authentication records generated from past product authentication messages associated with the product; and returning information derived from at least one existing product authentication record to the client terminal based on a comparison between the new product authentication record and the at least one existing product authentication record. In accordance with some embodiments of the present application, a computer server includes one or more processors; memory; and one or program modules stored in the memory for performing the method mentioned above. In accordance with some embodiments of the present application, a non-transitory computer readable storage medium stores one or more program modules configured for execution by a computer server that includes one or more processors and memory for performing the method mentioned above.

In accordance with some embodiments of the present application, a computer-implemented method for product anti-counterfeiting is performed at a mobile device having one or more processors and memory for storing one or more program modules to be executed by the one or more processors. The method includes: acquiring an anti-counterfeiting two-dimension code corresponding to a product to be authenticated; parsing the anti-counterfeiting two-dimension code to obtain signature content and a digital signature corresponding to the signature content; authenticating the digital signature with the signature content; and determining the product to be a product authenticated by its issuer when the digital signature and the signature content pass the authentication. In accordance with some embodiments of the present application, a mobile device includes one or more processors; memory; and one or program modules stored in the memory for performing the method mentioned above. In accordance with some embodiments of the present application, a non-transitory computer readable storage medium stores one or more program modules configured for execution by a mobile device that includes one or more processors and memory for performing the method mentioned above.

### BRIEF DESCRIPTION OF DRAWINGS

The aforementioned implementation of the invention as well as additional implementations will be more clearly understood as a result of the following detailed description of the various aspects of the invention when taken in conjunction with the drawings. Like reference numerals refer to corresponding parts throughout the several views of the drawings.

In order to more clearly describe the technical scheme of the embodiment of the present application, a brief introduction will be made to the accompanying drawings depicted in the description of the embodiments. Obviously, the accompanying drawings depicted below are only some of the embodiments of the present application. The ordinary skilled in the art will obtain other accompanying drawings according to these without the use of the creative effort.

FIG. 1 is a flow chart of a product anti-counterfeiting method according to an embodiment of the present application;

FIG. 2 is a flow chart of a product anti-counterfeiting method according to another embodiment of the present application;

FIG. 3A is a flow chart of a product anti-counterfeiting method according to yet another embodiment of the present application;

FIG. 3B is a schematic diagram showing that a terminal displays the product information provided by the issuer according to still another embodiment of the present application;

FIG. 3C is another schematic diagram showing that a terminal displays the product information provided by the issuer according to still another embodiment of the present application;

FIG. 3D is another schematic diagram showing that a terminal displays the product information provided by the issuer according to still another embodiment of the present application;

FIG. 4A is a flow chart of a product anti-counterfeiting method according to still another embodiment of the present application;

FIG. 4B is a schematic diagram showing that a terminal displays the product information provided by the issuer according to still another embodiment of the present application;

FIG. 4C is a schematic diagram showing that a terminal displays the product information provided by the issuer according to still another embodiment of the present application;

FIG. 5 is a flow chart of a product anti-counterfeiting method according to still another embodiment of the present application;

FIG. 6 is a structural block diagram of a product anti-counterfeiting apparatus according to an embodiment of the present application;

FIG. 7A is a structural block diagram of a product anti-counterfeiting apparatus according to another embodiment of the present application;

FIG. 7B is another structural block diagram of a product anti-counterfeiting apparatus according to another embodiment of the present application;

FIG. 7C is yet another structural block diagram of a product anti-counterfeiting apparatus according to another embodiment of the present application;

FIG. 8 is a structural block diagram of a product anti-counterfeiting apparatus according to an embodiment of the present application;

FIG. 9 is a structural block diagram of a product anti-counterfeiting apparatus according to another embodiment of the present application; and

FIG. 10 is a structural diagram of components of an authentication server according to an embodiment of the present application.

### DETAILED DESCRIPTION

In order to make the objects, technical schemes and advantages of the present application more clear and apparent, embodiments of the present application will now be described in further detail with reference to accompanying drawings. Obviously, some, but not all embodiments of the invention are described. Based on the embodiments of the present application, all other embodiments obtained by the ordinary skilled in the art without creative effort are all within the protective scope of the present application.

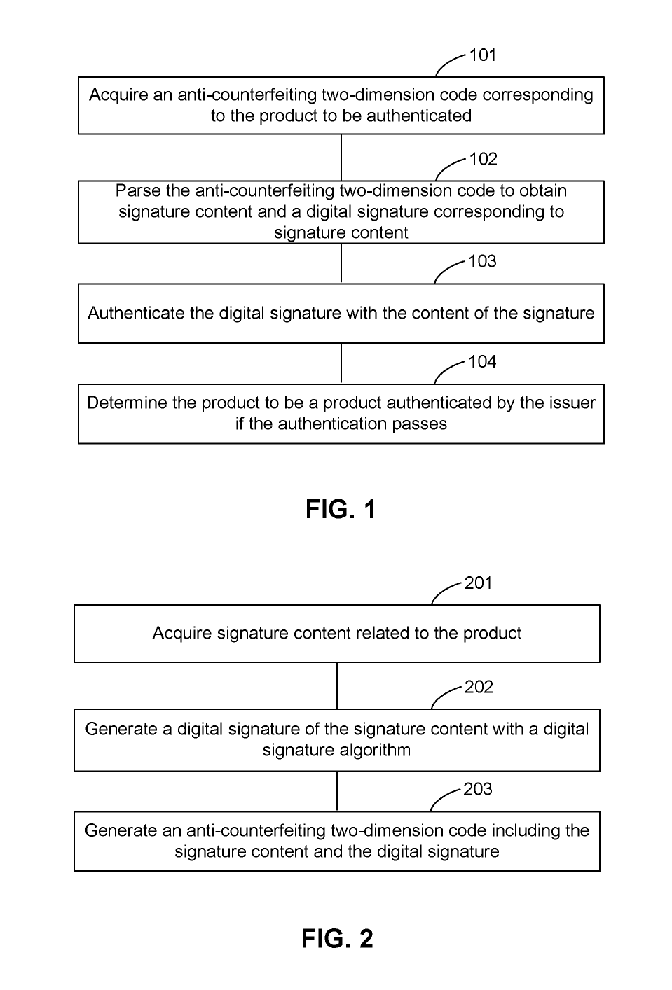

As shown in FIG. 1, there is shown a flow chart of a product anti-counterfeiting method according to an embodiment of the present application, which may be implemented in a two-dimension code authentication terminal (e.g., a smartphone), and the method may comprise the following steps.

Step 101, acquire an anti-counterfeiting two-dimension code (e.g., a quick-response (QR) code) corresponding to the product to be authenticated.

Step 102, parse the anti-counterfeiting two-dimension code to obtain signature content and a digital signature corresponding to the signature content. In some embodiments, the digital signature is used for authenticating whether the product is a product authenticated by the issuer (e.g., the manufacturer) of the product.

Step 103, authenticate the digital signature with the content of the signature.

Step 104, determine the product to be a product authenticated by the issuer when the digital signature and the signature content pass the authentication.

In conclusion, according to the product anti-counterfeiting method provided by this embodiment, a two-dimension code authentication terminal performs the steps of acquiring the anti-counterfeiting two-dimension code corresponding to the product to be authenticated, parsing the anti-counterfeiting two-dimension code to obtain the signature content and digital signature corresponding to the signature content, and authenticating the digital signature according to the signature content. When the digital signature passes the authentication, the product is determined to be a product authenticated by the issuer. Thus, the problem in the conventional approaches that the operation for determining the authenticity of the product is very complicated to the user is solved. The effect that the user can learn the authenticity of the product conveniently just by scanning an anti-counterfeiting two-dimension code corresponding to the product is achieved.

As shown in FIG. 2, there is shown a flow chart of a product anti-counterfeiting method according to an embodiment of the present application, which may be implemented in a two-dimension code generation terminal (e.g., a smartphone), and the method may comprise the following steps.

Step 201, acquire signature content related to the product.

Step 202, generate a digital signature of the signature content with a digital signature algorithm. For example, the digital signature is used for authenticating whether the product is a product authenticated by the issuer.

Step 203, generate an anti-counterfeiting two-dimension code including the signature content and the digital signature.

In conclusion, according to the product anti-counterfeiting method provided by this embodiment, a two-dimension code authentication terminal performs the steps of acquiring the signature content related to the product, generating the digital signature of the signature content and generating the anti-counterfeiting two-dimension code including the signature content and the digital signature. An end user who wants to learn the authenticity of a product may do so by scanning the anti-counterfeiting two-dimension code of the product. Thus, the problem in the conventional approaches that the operation for determining the authenticity of the product is very complicated to the end user is solved. The effect that the user can learn the authenticity of the product conveniently just by scanning the anti-counterfeiting two-dimension code corresponding to the product is achieved.

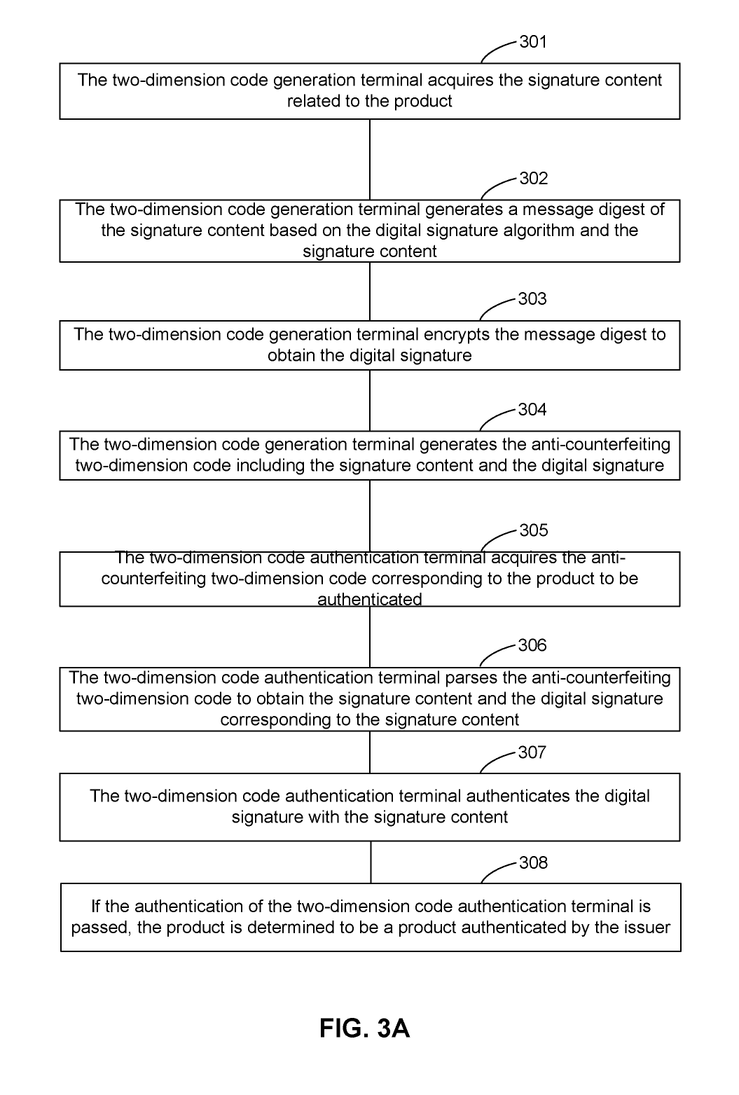

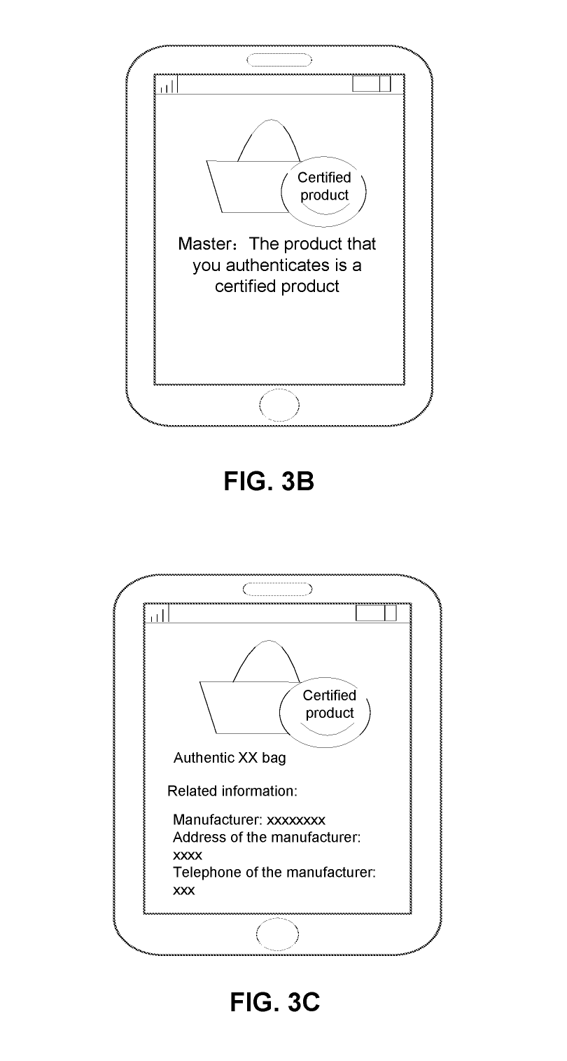

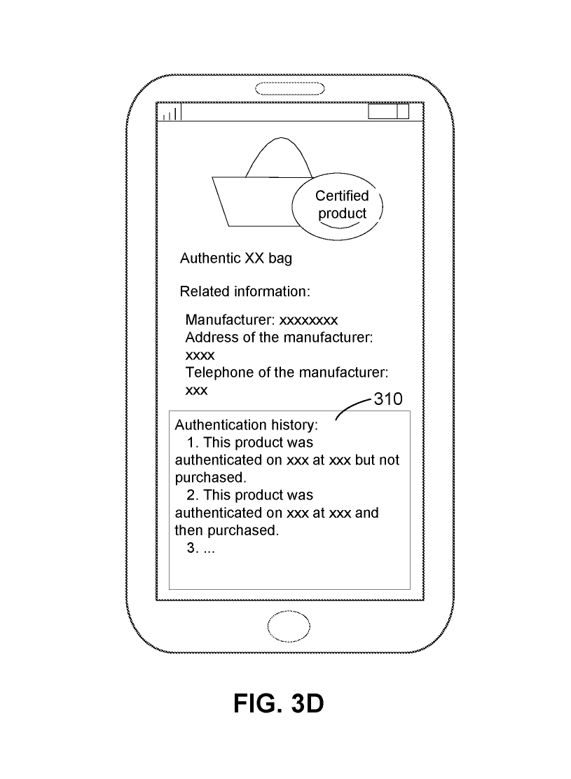

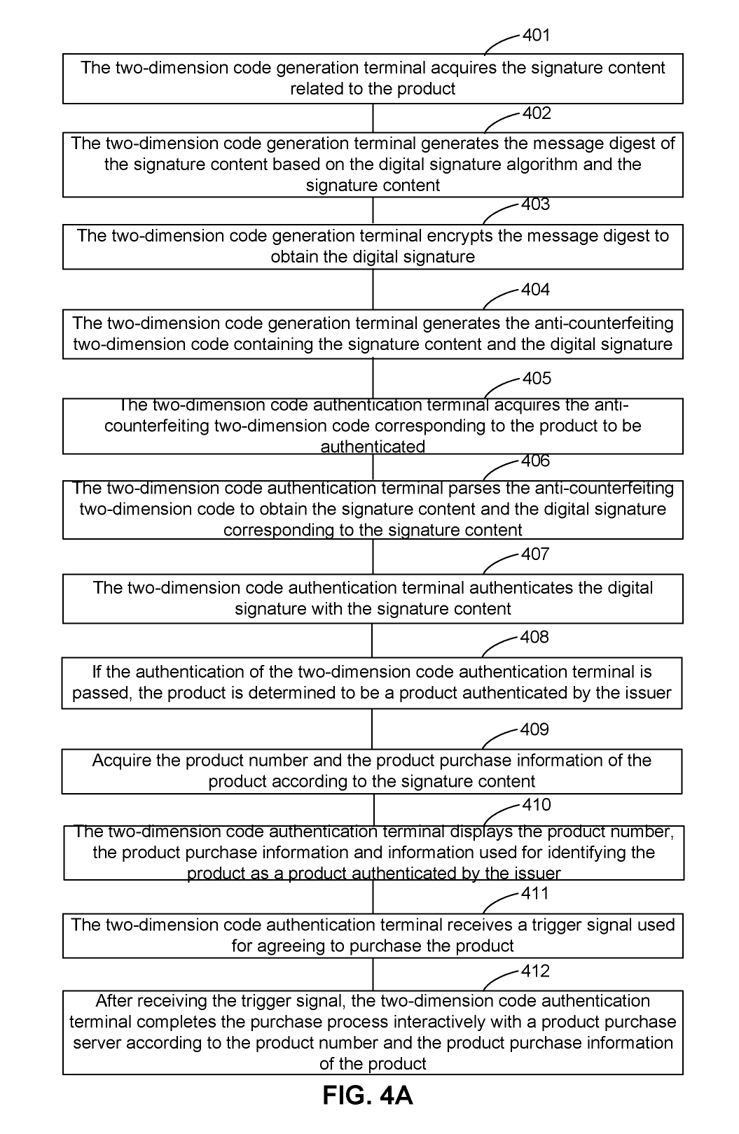

As shown in FIG. 3A, there is shown a flow chart of a product anti-counterfeiting method according to an embodiment of the present application, and the method may comprise the following steps.

Step 301, the two-dimension code generation terminal acquires the signature content related to the product.

The two-dimension code generation terminal may acquire the signature content related to the product, wherein the two-dimension code generation terminal may be a terminal (e.g., a smartphone) used by a manufacturer or a third party entity cooperating with the manufacturer. When the two-dimension code generation terminal is a terminal used by the manufacturer, it may read the stored signature content directly. When the two-dimension code generation terminal is a terminal used by the third party entity, the third party entity may reach an agreement with the manufacturer on the signature content in advance, so that the terminal used by the third party entity may acquire agreed-upon signature content from the manufacturer. In actual implementation, the third party entity may be an entity cooperating with the manufacturer and capable of generating a digital signature function or a payment processing entity cooperating with the manufacturer and providing the payment function, and this embodiment has no limit on the specific implementation of the third party entity.

In some embodiments, the signature content may include any information related to the product, such as product specifications, name, number of assembly line for producing the product, date of manufacture, expiration date, makings, manufacturer name, address and telephone of the manufacturer and the like, or a link address of the above information. In some embodiments, the signature content also includes past authentication history records of the product, each record including a timestamp, a location and a binary value indicating whether the product has been purchased or not. For example, the timestamp indicates when an authentication message of the product was generated and the location indicates where the authentication message was generated. As will be described below, the past authentication history is used for further authentication of the authenticity of the product. In actual implementation, the signature content may also contain a portion of the above information and the link address thereof, and this embodiment has no limit on the specific composition of the signature content.

Step 302, the two-dimension code generation terminal generates a message digest of the signature content based on the digital signature algorithm and the signature content.

After acquiring the signature content, the two-dimension code generation terminal generates the message digest of the signature content based on the digital signature algorithm and the signature content, wherein the digital signature algorithm may be a RSA algorithm or an SSF33 cryptographic algorithm. By taking the RSA algorithm as an example of the digital signature algorithm, the two-dimension code generation terminal may take the signature content as an input of an one-way function provided by the digital signature algorithm and convert it into an output of the one-way function as the message digest of the signature content, wherein the one-way function refers to a function that the output can be calculated from the input, but not vice versa.

It should be noted that when the two-dimension code generation terminal is a terminal used by the manufacturer or the payment processing entity, the two-dimension code generation terminal needs to acquire the permission to perform the digital signature from the authority in advance in order to be able to digitally sign the signature content, and generate the message digest of the signature content after acquiring the permission.

Step 303, the two-dimension code generation terminal encrypts the message digest to obtain the digital signature.

After generating the message digest of the signature content, the two-dimension code generation terminal encrypts the message digest to obtain the digital signature. Specifically, the two-dimension code generation terminal encrypts the message digest using a preassigned private key to obtain an encrypted signature and take the encrypted signature as the digital signature. In some embodiments, the digital signature is used for authenticating whether the product is a product authenticated by the issuer.

Moreover, when the two-dimension code authentication terminal needs to authenticate whether the product is a product authenticated by the issuer while the two-dimension code authentication terminal is not connected with an authentication server, the signature content and the digital signature are used by the two-dimension code authentication terminal to authenticate the digital signature according to the signature content and display the product information provided by the issuer when the digital signature passes the authentication.

When the two-dimension code authentication terminal needs to authenticate whether the product is a product authenticated by the issuer while the two-dimension code authentication terminal is connected with the authentication server, the signature content and the digital signature are used by the two-dimension code authentication terminal to authenticate the digital signature according to the signature content and by the authentication server to count the number of times that the product has been authenticated according to the authentication message and detect whether the number of authentications reaches a maximum number of authentications. The authentication message includes the signature content and/or the digital signature. Thus, when the digital signature passes the authentication of the two-dimension code authentication terminal while the detection result of the authentication server is that the number of authentications does not reach the maximum number of authentications, the two-dimension code authentication terminal displays the product information provided by the issuer.

Step 304, the two-dimension code generation terminal generates the anti-counterfeiting two-dimension code including the signature content and the digital signature.

After obtaining the digital signature of the signature content, the two-dimension code generation terminal generates an anti-counterfeiting two-dimension code including the signature content and the digital signature.

Meanwhile, after the two-dimension code generation terminal generates the anti-counterfeiting two-dimension code, in order to establish a correspondence between the anti-counterfeiting two-dimension code and the product, the manufacturer may stick a label including the anti-counterfeiting two-dimension code generated by the two-dimension code generation terminal on the surface or a packing box of the product such that the user may acquire the anti-counterfeiting two-dimension code corresponding to the product when trying to determine the authenticity of the product.

One point to be noted is that when the two-dimension code generation terminal is a terminal used by the manufacturer, the two-dimension code generation terminal may derive the anti-counterfeiting two-dimension code directly and establish a relationship between the anti-counterfeiting two-dimension code and the product after generating the anti-counterfeiting two-dimension code. When the two-dimension code generation terminal is a terminal used by the third party entity, the manufacturer may acquire, from the two-dimension code generation terminal, the anti-counterfeiting two-dimension code generated by the two-dimension code generation terminal, in a predetermined manner. For example, the two-dimension code generation terminal is provided with a two-dimension code storage system, and after generating the anti-counterfeiting two-dimension code, the two-dimension code generation terminal enters the generated anti-counterfeiting two-dimension code into the storage system. The manufacturer then logs into the storage system using a username and a password authorized by the third party entity and downloads the anti-counterfeiting two-dimension code from the storage system and establishes a relationship between the product and the anti-counterfeiting two-dimension code after downloading the anti-counterfeiting two-dimension code. Or the two-dimension code generation terminal and the terminal used by the manufacturer use a certain application software at the same time, and after generating the anti-counterfeiting two-dimension code, the two-dimension code generation terminal synchronizes the generated anti-counterfeiting two-dimension code to the terminal used by the manufacturer through the application software such that the manufacturer may attach the received anti-counterfeiting two-dimension code to the surface or the packing box of the product. This embodiment has no limit on the specific manner of implementation thereof. In addition, when the two-dimension code generation terminal is a terminal used by the third party entity, the third party entity must comply with an anti-counterfeiting cooperation agreement signed with the manufacturer and secure the anti-counterfeiting two-dimension code generated. It should not reveal the anti-counterfeiting two-dimension code to other manufacturers without the permission of the manufacturer so as to prevent other manufacturers from using the corresponding anti-counterfeiting two-dimension code for counterfeiting. Detailed description thereof will not be repeated here. In some embodiments, when the manufacturer establishes the correspondence between the anti-counterfeiting two-dimension code and the product, the manufacturer may form the anti-counterfeiting two-dimension code on the product by a special manufacturing technique so as to prevent duplication and fraudulent use of the anti-counterfeiting two-dimension code by others. This embodiment has no limit on the specific manner of implementation thereof.

Another point to be noted is that the more information in the anti-counterfeiting two-dimension code, the more complex the composition of the anti-counterfeiting two-dimension code, and the lower the accuracy of identification is when the anti-counterfeiting two-dimension code is identified. So that the two-dimension code generation terminal may reduce the amount of information in the anti-counterfeiting two-dimension code and improves the accuracy of identification when identifying the anti-counterfeiting two-dimension code by taking the link address of the information as the signature content.

Step 305, the two-dimension code authentication terminal acquires the anti-counterfeiting two-dimension code corresponding to the product to be authenticated.

When the user wants to authenticate whether a certain product is a product authenticated by the issuer, the user may use the two-dimension code authentication terminal to acquire the anti-counterfeiting two-dimension code corresponding to the product to be authenticated. Specifically, since the anti-counterfeiting two-dimension code is typically displayed on the surface or the packing box of the product, the user may use a two-dimension code scanning function of the two-dimension code authentication terminal to scan the anti-counterfeiting two-dimension code on the surface or the packing box of the product. In actual implementation, as an instant messenger application may provide the two-dimension code scanning function, the two-dimension code authentication terminal may scan the anti-counterfeiting two-dimension code corresponding to the product through the installed instant messenger application.

For example, when the user chooses a handbag of a famous brand in a market, in order to determine whether the handbag is manufactured by an authorized manufacturer and authenticated by a product issuer, the user may use the two-dimension code scanning function of the instant messenger application installed in a mobile phone to scan the anti-counterfeiting two-dimension code arranged at a certain position of the handbag.

Step 306, the two-dimension code authentication terminal parses the anti-counterfeiting two-dimension code to obtain the signature content and the digital signature corresponding to the signature content.

The two-dimension code authentication terminal may parse the acquired anti-counterfeiting two-dimension code to obtain the signature content and the digital signature corresponding to the signature content.

Step 307, the two-dimension code authentication terminal authenticates the digital signature with the signature content.

After obtaining the signature content and the digital signature corresponding to the signature content through parsing, the two-dimension code authentication terminal authenticates the digital signature with the signature content. Specifically, the step that the two-dimension code authentication terminal authenticates the digital signature with the signature content may comprise the following steps.

First, the two-dimension code authentication terminal decrypts the digital signature to obtain the decrypted message digest.

The digital signature in the anti-counterfeiting two-dimension code is a ciphertext signature encrypted by the private key, so that when authenticating the digital signature, the two-dimension code authentication terminal needs to decrypt the digital signature obtained through parsing so as to obtain the decrypted message digest. Specifically, as the public key corresponding to the private key is open to the public, after obtaining the digital signature through parsing, the two-dimension code authentication terminal may decrypt the digital signature with the public key and the digital signature so as to obtain the decrypted message digest. In some embodiments, the two-dimension code authentication terminal has already acquired, in advance, the public key which pairs with the private key used by the two-dimension code generation terminal when generating the digital signature in the anti-counterfeiting two-dimension code.

Second, the two-dimension code authentication terminal generates the message digest of the signature content.

The two-dimension code authentication terminal may also generate the message digest of the signature content. Specifically, as the one-way function used by the two-dimension code generation terminal when generating the digital signature is open to the public, in order to perform the subsequent steps, the two-dimension code authentication terminal generates the message digest of the signature content obtained through parsing according to the same one-way function as the one used when generating the digital signature.

Third, the two-dimension code authentication terminal detects whether the message digest obtained through decrypting matches the generated message digest.

After obtaining the decrypted message digest and generating the message digest of the signature content, the two-dimension code authentication terminal detects whether the message digest obtained through decrypting matches the generated message digest.

Fourth, when the detection result is a match, the digital signature passes the authentication.

If the detection result of the two-dimension code authentication terminal is a match, the two-dimension code authentication terminal may determine that the digital signature passes the authentication.

Step 308, when the authentication of the two-dimension code authentication terminal is passed, the product is determined to be a product authenticated by the issuer.

If the authentication result is that the digital signature passes the authentication of the two-dimension code authentication terminal, the two-dimension code authentication terminal may determine the product to be a product authenticated by the issuer. At this time, in order to notify the user of the authentication result, the two-dimension code authentication terminal may provide information indicating that the product is authenticated by the issuer, for example, by displaying the information shown in FIG. 3B or playing audiovisual information, etc. This embodiment has no limit on the reminding manner in which the two-dimension code authentication terminal reminds the user that the product is a product authenticated by the issuer. In actual implementation, the two-dimension code authentication terminal may play the audiovisual information containing the use instruction of the product such that the user may acquire how to use the product as well as notes for using the product while learning the authenticity of the product. Thus, the user is relieved from feeling bored when reading an instruction for use, and the user experience is improved.

In actual implementation, when the two-dimension code authentication terminal prompts the user by displaying the information, the two-dimension code authentication terminal may also display at least some information in the signature content (for example, as shown in an interface of FIG. 3C) while displaying the information indicating that the product is a product authenticated by the issuer (that is, a certified product). Thus, if the user found that the two-dimension code authentication terminal shows the product is a certified product, but the displayed information in the signature content does not match with the actual information of the product, the user may determine the product to be a counterfeit, thereby improving the accuracy of authenticating the product.

If the authentication result is that the digital signature fails the authentication of the two-dimension code authentication terminal, the two-dimension code authentication terminal may determine the product to be a counterfeit. In actual implementation, when the signature content includes a compensation scheme in case that the product is a counterfeit, and when the two-dimension code authentication terminal determines the product to be a counterfeit, and the user has already purchased the product, the user may request a dealer for reimbursement by virtue of a reimbursement policy stated in the signature content acquired by the two-dimension code authentication terminal. This embodiment has no limit thereon.

In some embodiments, a product to be authenticated using the two-dimension code authentication terminal has an authentication history of its own. The authentication history provides additional protection for consumers from counterfeit products. For example, the anti-counterfeiting two-dimension code may include in itself the authentication history of the product or a link thereto. As shown in FIG. 3D, when the two-dimension code authentication terminal displays the authentication result, the authentication history 310 is also displayed along with the other information related to the product to be authenticated. In this example, the authentication history 310 includes a list of authentication history records, each record indicating when and where the product (or more specifically, the anti-counterfeiting two-dimension code) was authenticated and whether the product was purchased or not after the corresponding authentication. From browsing the authentication history, the user of the two-dimension code authentication terminal can have a better understanding whether or not the product is authentic or not. Using the handbag example, when the authentication history indicates that the handbag has been authenticated multiple times at locations where it is less likely for the handbag to be found, the user may have a reasonable doubt about its authenticity even if the other steps described above suggest the opposite. In other words, the authentication history is more or less a soft indicator of the authenticity of the product. It may be displayed to the user of the two-dimension code authentication terminal only when the authentication history meets certain predefined conditions (e.g., when the number of authentication messages associated with the product exceeds a threshold, the number of unique locations associated with the authentication messages exceeds a threshold, or the product associated with the anti-counterfeiting two-dimension code has been sold for more than a predefined number of times, etc.).

In conclusion, according to the product anti-counterfeiting method provided by this embodiment, the signature content related to the product is digitally signed, and the anti-counterfeiting two-dimension code containing the signature content and the digital signature is generated. Thus, when trying to determine the authenticity of the product, the user displays the product information provided by the issuer by acquiring the anti-counterfeiting two-dimension code corresponding to the product, parsing the anti-counterfeiting two-dimension code to obtain the signature content and the digital signature thereof, authenticating the digital signature according to the signature content and passing the authentication with the digital signature. Therefore, the problem in the conventional approaches that the operation for determining the authenticity of the product is very complicated to the user is solved. The effect that the user can learn the authenticity of the product conveniently just by scanning the anti-counterfeiting two-dimension code corresponding to the product is achieved.

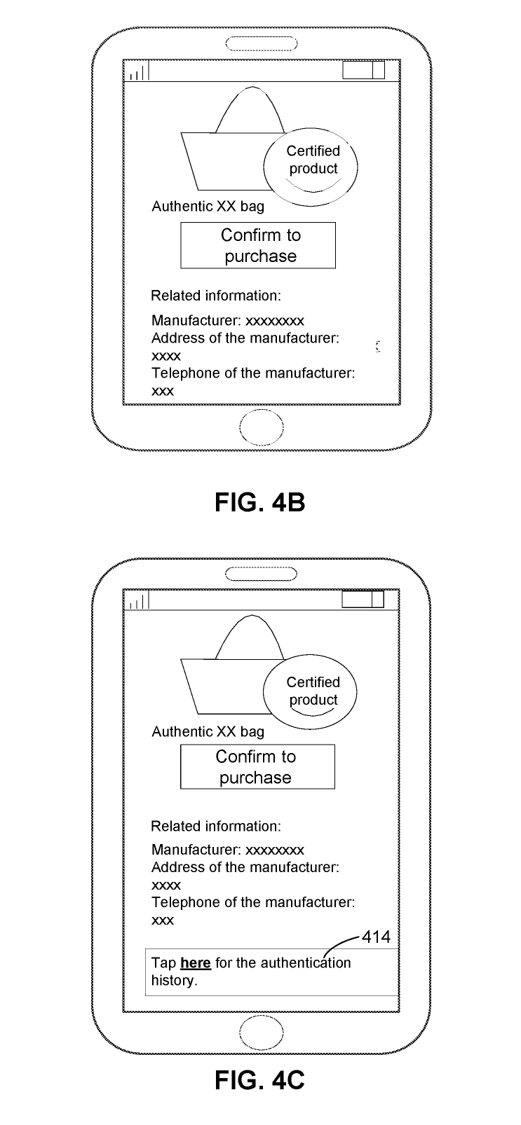

As shown in FIG. 4A, there is shown a flow chart of a product anti-counterfeiting method according to another embodiment of the present application. Unlike the embodiment described above, in this embodiment after the two-dimension code authentication terminal authenticates the authenticity of the product, the user may purchase the product directly. The product anti-counterfeiting method comprises the following steps.

Step 401, the two-dimension code generation terminal acquires the signature content related to the product.

The two-dimension code generation terminal may acquire the signature content related to the product. In some embodiments, the two-dimension code generation terminal may be a terminal used by a manufacturer or a third party entity cooperating with the manufacturer. When the two-dimension code generation terminal is a terminal used by the manufacturer, it may read the stored signature content directly. When the two-dimension code generation terminal is a terminal used by the third party entity, the third party entity may sign an anti-counterfeiting cooperation agreement with the manufacturer and reach an agreement on the signature content in advance, and acquire the agreed-upon signature content from the manufacturer. In actual implementation, the third party entity may be an entity cooperating with the manufacturer and capable of generating a digital signature function, or a payment processing entity cooperating with the manufacturer and providing a payment function, and this embodiment has no limit on the specific implementation of the third party entity.

Specifically, the step that the two-dimension code generation terminal acquires the signature content related to the product may comprise any one of the following manners.

First, the two-dimension code generation terminal acquires number and product purchase information of the product and uses the product number and product purchase information acquired as the signature content.

In some embodiments, the product number refers to an identification for uniquely identifying a product. In actual implementation, the product number may be a serial number or a production sequence number, and the present embodiment has no limit thereon. The product purchase information refers to the information used for guiding the user to purchase the product. In actual implementation, the product purchase information may comprise product specifications, name, number of assembly line for producing the product, date of manufacture, expiration date, makings, manufacturer name, address and telephone of the manufacturer, etc.

Second, the two-dimension code generation terminal acquires a link address of the product number and product purchase information of the product and uses the link address acquired as the signature content.

In actual implementation, the product number and the product purchase information may be stored in a certain webpage, so that in order to perform the subsequent steps, the two-dimension code generation terminal may also acquire the link address of the product number and the product purchase information of the product stored and use the link address acquired as the signature content.

It should be noted that in actual implementation, the signature content may also comprise the product number and a part of the product purchase information as well as the link address, and this embodiment has no limit thereon.

Step 402, the two-dimension code generation terminal generates the message digest of the signature content based on the digital signature algorithm and the signature content.

After acquiring the signature content, the two-dimension code generation terminal generates the message digest of the signature content based on the digital signature algorithm and the signature content.

Step 403, the two-dimension code generation terminal encrypts the message digest to obtain the digital signature.

After generating the message digest of the signature content, the two-dimension code generation terminal encrypts the message digest to obtain the digital signature. Specifically, the two-dimension code generation terminal encrypts the message digest using a pre-assigned private key to obtain an encrypted signature and take the encrypted signature as the digital signature. In some embodiments, the digital signature is used for authenticating whether the product is a product authenticated by the issuer.

Moreover, when the two-dimension code authentication terminal needs to authenticate whether the product is a product authenticated by the issuer while the two-dimension code authentication terminal is not connected with an authentication server, the signature content and the digital signature are used by the two-dimension code authentication terminal to authenticate the digital signature according to the signature content and determine the product to be a product authenticated by the issuer when the digital signature passes the authentication.

When the two-dimension code authentication terminal needs to authenticate whether the product is a product authenticated by the issuer while the two-dimension code authentication terminal is connected with the authentication server, the signature content and the digital signature are used by the two-dimension code authentication terminal to authenticate the digital signature according to the signature content and by the authentication server to count the number of times that the product has been authenticated according to the authentication message and detect whether the number of authentications reach a maximum number of authentications. The authentication message includes the signature content and/or the digital signature. Thus, when the digital signature passes the authentication of the two-dimension code authentication terminal, and the detection result of the authentication server is that the number of authentications does not reach the maximum number of authentications, the two-dimension code authentication terminal displays the product information provided by the issuer.

Step 404, the two-dimension code generation terminal generates the anti-counterfeiting two-dimension code containing the signature content and the digital signature.

After obtaining the digital signature of the signature content, the two-dimension code generation terminal generates an anti-counterfeiting two-dimension code including the signature content and the digital signature.

Step 405, the two-dimension code authentication terminal acquires the anti-counterfeiting two-dimension code corresponding to the product to be authenticated.

When the user wants to authenticate whether a certain product is a product authenticated by the issuer, the user may use the two-dimension code authentication terminal to acquire the anti-counterfeiting two-dimension code corresponding to the product to be authenticated. Specifically, since the anti-counterfeiting two-dimension code is typically displayed on the surface or the packing box of the product, the user may use the two-dimension code scanning function of the two-dimension code authentication terminal to scan the anti-counterfeiting two-dimension code on the surface or the packing box of the product. In actual implementation, as the instant messenger application may provide the two-dimension code scanning function, the two-dimension code authentication terminal may scan the anti-counterfeiting two-dimension code corresponding to the product through the installed instant messenger application.

Step 406, the two-dimension code authentication terminal parses the anti-counterfeiting two-dimension code to obtain the signature content and the digital signature corresponding to the signature content.

The two-dimension code authentication terminal may parse the acquired anti-counterfeiting two-dimension code to obtain the signature content and the digital signature corresponding to the signature content.

Step 407, the two-dimension code authentication terminal authenticates the digital signature with the signature content.

After obtaining the signature content and the digital signature corresponding to the signature content through parsing, the two-dimension code authentication terminal authenticates the digital signature with the signature content. Specifically, the step that the two-dimension code authentication terminal authenticates the digital signature with the signature content may comprise the following steps.

First, the two-dimension code authentication terminal decrypts the digital signature to obtain the decrypted message digest.

The digital signature in the anti-counterfeiting two-dimension code is a ciphertext signature encrypted by the private key, so that when authenticating the digital signature, the two-dimension code authentication terminal needs to decrypt the digital signature obtained through parsing so as to obtain the decrypted message digest. Specifically, as the public key corresponding to the private key is open to the public, after obtaining the digital signature through parsing, the two-dimension code authentication terminal may use the public key and the digital signature for decryption so as to obtain the decrypted message digest. In some embodiments, the two-dimension code authentication terminal has already acquired the public key which pairs with the private key used by the two-dimension code generation terminal when generating the digital signature in the anti-counterfeiting two-dimension code in advance.

Second, the two-dimension code authentication terminal generates the message digest of the signature content.

The two-dimension code authentication terminal may also generate the message digest of the signature content. Specifically, as the one-way function used by the two-dimension code generation terminal when generating the digital signature is open to the public, the two-dimension code authentication terminal generates the message digest of the signature content obtained through parsing according to the same one-way function as the one used when generating the digital signature.

Third, the two-dimension code authentication terminal detects whether the message digest obtained through decrypting matches the generated message digest.

After obtaining the decrypted message digest and generating the message digest of the signature content, the two-dimension code authentication terminal detects whether the message digest obtained through decrypting matches the generated message digest.

Fourth, when the detection result is a match, the digital signature passes the authentication.

If the detection result of the two-dimension code authentication terminal is a match, the two-dimension code authentication terminal may determine that the digital signature passes the authentication.

Step 408, if the authentication of the two-dimension code authentication terminal is passed, the product is determined to be a product authenticated by the issuer.

If the authentication result is that the digital signature passes the authentication of the two-dimension code authentication terminal, the two-dimension code authentication terminal may determine the product to be a product authenticated by the issuer.

If the authentication result is that the digital signature fails the authentication of the two-dimension code authentication terminal, the two-dimension code authentication terminal may determine the product to be a counterfeit.

It should be noted that the steps 402 to 408 are similar to the steps 302 to 308 of the above embodiment, and reference is made to the above embodiment for technical details. Detailed description thereof will not be repeated here.

Step 409, the two-dimension code authentication terminal acquires the product number and the product purchase information of the product according to the signature content.

The two-dimension code authentication terminal may acquire the product number and the product purchase information of the product according to the signature content obtained through parsing. Specifically, as the signature content may directly comprise the product number and the product purchase information of the product or the link address of the product number and the product purchase information of the product, the step that the two-dimension code authentication terminal acquires the product number and the product purchase information of the product according to the signature content may comprise the following steps.

First, when the signature content comprises the product number and the product purchase information of the product, the two-dimension code authentication terminal reads the product number and product purchase information of the product.

Second, when the signature content includes the link address of the product number and product purchase information of the product, the two-dimension code authentication terminal sends an information acquisition request used for acquiring the product number and the product purchase information of the product to a storage server according to the link address and receives the product number and the product purchase information of the product returned from the storage server.

When the signature content includes the link address of the product number and product purchase information of the product, the two-dimension code authentication terminal sends the information acquisition request used for acquiring the product number and the product purchase information of the product to the storage server in order to acquire the product number and the product purchase information of the product. In some embodiments, the information acquisition request may include the link address. After receiving the information acquisition request, the storage server may return the product number and the product purchase information stored in a page corresponding to the link address to the two-dimension code authentication terminal, and correspondingly, the two-dimension code authentication terminal receives the product number and the product purchase information returned from the storage server.

It should be noted that this step may be performed at any step after the step 406. In this embodiment, the step is performed in step 409, and the embodiment has no limit on the specific performing time.

Step 410, the two-dimension code authentication terminal displays the product number, the product purchase information and information used for identifying the product as a product authenticated by the issuer.

After acquiring the product number and the product purchase information, the two-dimension code authentication terminal may display the product number, the product purchase information and the information used for identifying the product as a product authenticated by the issuer.

In actual implementation, the two-dimension code authentication terminal may also display selection option used for agreeing to purchase the product. The user may request to purchase the product by triggering the selection information, referring specifically to FIG. 4B, and this embodiment has no limit thereon.

Step 411, the two-dimension code authentication terminal receives a trigger signal used for agreeing to purchase the product.

After determining the product to be a product authenticated by the issuer according to the content displayed by the two-dimension code authentication terminal, the user may choose to purchase the product. At this time, the user may initiate the trigger signal used for purchasing the product, and correspondingly, the two-dimension code authentication terminal may receive the trigger signal used for agreeing to purchase the product. In actual implementation, if the two-dimension code authentication terminal only displays the product number, the product purchase information and the information used for identifying the product as a product authenticated by the issuer, the user may click any position of a display interface to trigger the product purchase. When the two-dimension code authentication terminal displays the information shown in FIG. 4B, the user may directly click a “confirm to purchase” to trigger the redemption. This embodiment has no limit on the specific implementation form of the trigger signal. In some embodiments (shown in FIG. 4C), a link 414 to the authentication history is displayed on the two-dimension code authentication terminal. As noted above, the authentication history may provide unique information as to the authenticity of the product to be sold. If still uncertain about the authenticity of the product, the user of the two-dimension code authentication terminal may tap the link 414 and bring up the authentication history on the screen. From reviewing the authentication history, the user would have a better understanding about the authenticity of the product.

Step 412, after receiving the trigger signal, the two-dimension code authentication terminal completes the product purchase process interactively with a redemption server according to the product number and the product purchase information of the product.

After receiving the trigger signal, the two-dimension code authentication terminal may complete the product purchase process interactively with the redemption server according to the product number and the product purchase information of the product.

Specifically, the product dealer may register the anti-counterfeiting two-dimension code of the product with the redemption server in advance and register such information as redemption value, a user account for receiving the redemption value and the like at the same time. Thus, after receiving the trigger signal of agreeing the product purchase, the two-dimension code authentication terminal may send the product number to the redemption server. The redemption server may determine the redemption value of the product and the user account for receiving the redemption value according to the product number and transfer the redemption value from a redemption account bound with the two-dimension code authentication terminal to the user account for receiving the redemption value, thereby completing the product purchase process of the product.

For example, the instant messenger application is bound to a certain redemption account of the user, and then the redemption server may subtract the redemption value from the account value of the redemption account and add the redemption value to the user account for receiving the redemption value. After completing the above steps, the redemption server feeds confirmation information back to the two-dimension code authentication terminal. After the user displays the confirmation information to the dealer through the two-dimension code authentication terminal, the dealer gives the user corresponding product, and the product purchase process is completed after the user gets the product. In actual implementation, the redemption server may also feed the confirmation information back to the dealer who registered the anti-counterfeiting two-dimension code, and after receiving the confirmation information, the dealer gives the user the corresponding product. The product purchase process is completed after the user gets the product, and this embodiment has no limit on the specific implementation form thereof.

In actual implementation, when the anti-counterfeiting two-dimension code comprises the redemption value of the product and the user account for receiving the redemption value at the same time, the dealer may need not to register with the redemption server. After receiving the trigger signal, the two-dimension code authentication terminal directly sends the product number, the redemption value and the user account for receiving the redemption value to the redemption server which directly transfers the redemption value from the redemption account bound with the two-dimension code authentication terminal to the user account for receiving the redemption value.

In an application scenario of this embodiment, when shopping in the market, the user may use the terminal to scan the anti-counterfeiting two-dimension code corresponding to the selected product. After authenticating the anti-counterfeiting two-dimension code, the terminal receives the trigger signal used for agreeing the product purchase and sends the product number obtained through parsing according to the anti-counterfeiting two-dimension code to the redemption server. After determining the redemption value corresponding to the product number and the user account for receiving the redemption value, the redemption server directly transfers the redemption value from the redemption account bound with the terminal to the user account for receiving the redemption value. And after the transfer is complete, the redemption server feeds the confirmation information back to the dealer who registered the corresponding anti-counterfeiting two-dimension code with the redemption server. After receiving the confirmation information, the dealer gives the user the corresponding product, thereby completing the product purchase process. Thus, the user may complete the product purchase process directly while learning the authenticity of the product, thereby avoiding the complicated operation of taking out a purse and then taking out cash or a bank card from the purse to make payment by the user after the user has determined the authenticity of the product, and enhancing convenience for user. In addition, as the user may use his or her terminal to make payment directly, the dealer does not have to arrange a POS machine, thereby reducing the operating cost of the dealer.

In another application scenario of this embodiment, a certain vending machine may scan the anti-counterfeiting two-dimension code of a product to be sold and display the anti-counterfeiting two-dimension code obtained through scanning on the display screen of the vending machine. After selecting a certain product and wanting to determine the authenticity of the product, the user may use the terminal to scan the anti-counterfeiting two-dimension code corresponding to the product on the display screen, and after authenticating the anti-counterfeiting two-dimension code, the terminal receives the trigger signal of the user agreeing to purchase the product. After receiving the trigger signal, the terminal sends the product number to the redemption server. The redemption server directly transfers the redemption value from the redemption account bound with the terminal to the user account for receiving the redemption value after determining the redemption value corresponding to the product number and the user account for receiving the redemption value, and returns the confirmation information to the dealer who registered the anti-counterfeiting two-dimension code after the transfer is complete. The dealer controls the vending machine to deliver the corresponding product, and the user gets the product delivered by the vending machine, thereby completing the whole redemption process. Thus, the user may purchase the product in the vending machine while determining the authenticity of the product, thereby avoiding the complicated operation of taking out a purse and then taking out cash or a bank card from the purse to make payment by the user after the user has determined the authenticity of the product, and enhancing convenience for user.

In conclusion, according to the product anti-counterfeiting method provided by this embodiment, the signature content related to the product is digitally signed, and the anti-counterfeiting two-dimension code containing the signature content and the digital signature is generated. Thus when trying to determine the authenticity of the product, the user displays the product information provided by the issuer by acquiring the anti-counterfeiting two-dimension code corresponding to the product, parsing the anti-counterfeiting two-dimension code to obtain the signature content and the digital signature thereof, authenticating the digital signature according to the signature content and passing the authentication with the digital signature. Therefore, the problem in the conventional approaches that the operation for determining the authenticity of the product is very complicated to the user is solved. The effect that the user can learn the authenticity of the product conveniently just by scanning the anti-counterfeiting two-dimension code corresponding to the product is achieved.

According to this embodiment, the signature content is provided with the product number and the product purchase information, and the two-dimension code authentication terminal may complete the product purchase process interactively with the redemption server through the product number and the product purchase information while determining the authenticity of the product, thereby realizing the combination of authenticity determination and product purchase and greatly enhancing the user convenience.

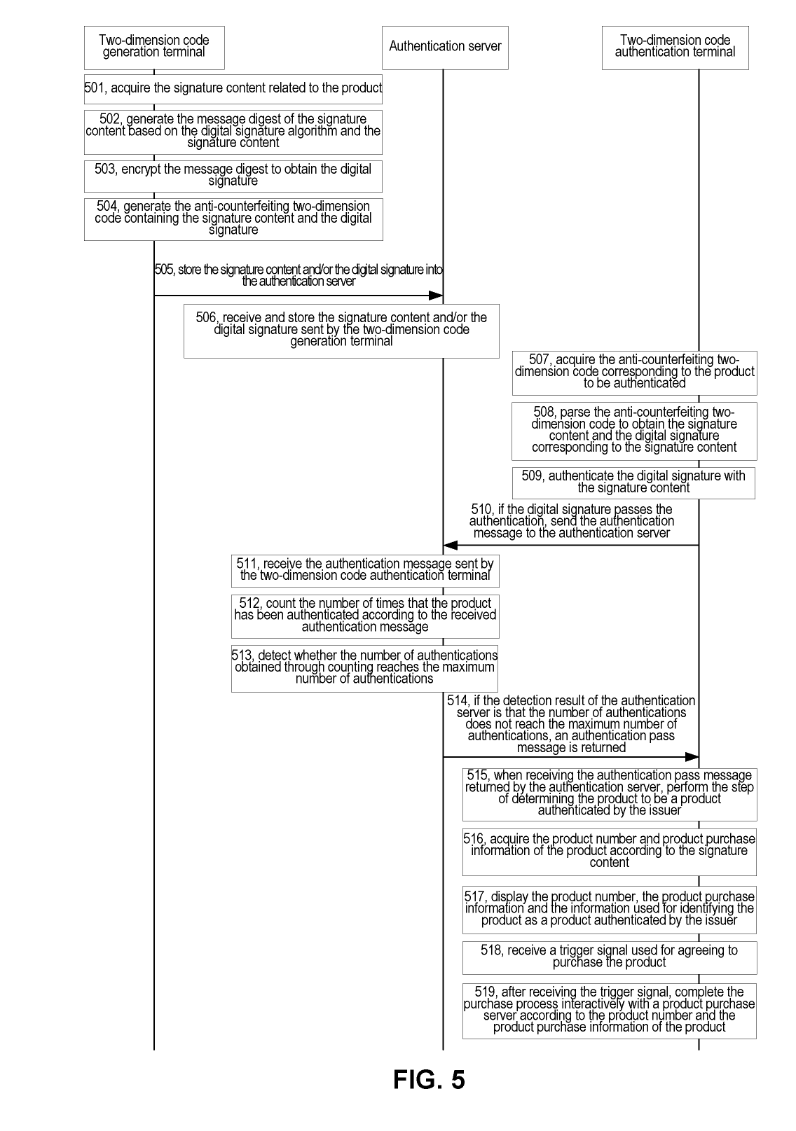

As shown in FIG. 5, there is shown a flow chart of a product anti-counterfeiting method according to another embodiment of the present application. Unlike the embodiment described above, in this embodiment, before determining the product to be a product authenticated by the issuer, the two-dimension code authentication terminal sends the authentication message to the authentication server for further authentication. The product anti-counterfeiting method comprises the following steps.

Step 501, the two-dimension code generation terminal acquires the signature content related to the product.

The two-dimension code generation terminal may acquire the signature content related to the product. In some embodiments, the two-dimension code generation terminal may be a terminal used by a manufacturer or a third party entity cooperating with the manufacturer. When the two-dimension code generation terminal is a terminal used by the manufacturer, it may read the stored signature content directly. When the two-dimension code generation terminal is a terminal used by the third party entity, the third party entity may sign an anti-counterfeiting cooperation agreement with the manufacturer and reach an agreement on the signature content in advance, and acquire the agreed-upon signature content from the manufacturer. In actual implementation, the third party entity may be an entity cooperating with the manufacturer and capable of generating a digital signature function, or a payment processing entity cooperating with the manufacturer and providing a payment function, and this embodiment has no limit on the specific implementation of the third party entity.

Specifically, the step that the two-dimension code generation terminal acquires the signature content related to the product may comprise any one of the following manners.

First, the two-dimension code generation terminal acquires the product number and the product purchase information of the product and uses the product number and the product purchase information acquired as the signature content.

Second, the two-dimension code generation terminal acquires the link address of the product number and product purchase information of the product and uses the link address acquired as the signature content.

It should be noted that in actual implementation, the signature content may also comprise part of the product purchase information and the link address, and this embodiment has no limit thereon.

Step 502, the two-dimension code generation terminal generates the message digest of the signature content based on the digital signature algorithm and the signature content.

After acquiring the signature content, the two-dimension code generation terminal generates the message digest of the signature content based on the digital signature algorithm and the signature content.

Step 503, the two-dimension code generation terminal encrypts the message digest to obtain the digital signature.

After generating the message digest of the signature content, the two-dimension code generation terminal encrypts the message digest to obtain the digital signature. Specifically, the two-dimension code generation terminal encrypts the message digest using a preassigned private key to obtain an encrypted signature and take the encrypted signature as the digital signature. In some embodiments, the digital signature is used for authenticating whether the product is a product authenticated by the issuer.

Moreover, when the two-dimension code authentication terminal needs to authenticate whether the product is a product authenticated by the issuer while the two-dimension code authentication terminal is not connected with an authentication server, the signature content and the digital signature are used by the two-dimension code authentication terminal to authenticate the digital signature according to the signature content and determine the product to be a product authenticated by the issuer when the digital signature passes the authentication.

When the two-dimension code authentication terminal needs to authenticate whether the product is a product authenticated by the issuer while the two-dimension code authentication terminal is connected with the authentication server, the signature content and the digital signature are used by the two-dimension code authentication terminal to authenticate the digital signature according to the signature content and by the authentication server to count the number of times that the product has been authenticated according to the authentication message and detects whether the number of authentications reach a maximum number of authentications. The authentication message includes the signature content and/or the digital signature. Thus, when the digital signature passes the authentication of the two-dimension code authentication terminal, and the detection result of the authentication server is that the number of authentications does not reach the maximum number of authentications, the two-dimension code authentication terminal displays the product information provided by the issuer.

Step 504, the two-dimension code generation terminal generates the anti-counterfeiting two-dimension code containing the signature content and the digital signature.

After obtaining the digital signature of the signature content, the two-dimension code generation terminal generates an anti-counterfeiting two-dimension code including the signature content and the digital signature.

It should be noted that the steps 501 to 504 are similar to the steps 401 to 404 of the above embodiment, and reference is made to the above embodiment for technical details. Detailed description thereof will not be repeated here.

Step 505, the two-dimension code generation terminal stores the signature content and/or the digital signature into the authentication server.

In order to perform the subsequent steps, after acquiring the signature content and generating the digital signature, the two-dimension code generation terminal stores the signature content, the digital signature or both of them into the authentication server.

Step 506, the authentication server receives and stores the signature content and/or the digital signature sent by the two-dimension code generation terminal.

Step 507, the two-dimension code authentication terminal acquires the anti-counterfeiting two-dimension code corresponding to the product to be authenticated.

When the user wants to authenticate whether a certain product is a product authenticated by the issuer, the user may use the two-dimension code authentication terminal to acquire the anti-counterfeiting two-dimension code corresponding to the product to be authenticated. Specifically, since the anti-counterfeiting two-dimension code is typically displayed on the surface or the packing box of the product, the user may use the two-dimension code scanning function of the two-dimension code authentication terminal to scan the anti-counterfeiting two-dimension code on the surface or the packing box of the product.

In actual implementation, as the instant messenger application may provide the two-dimension code scanning function, the two-dimension code authentication terminal may scan the anti-counterfeiting two-dimension code corresponding to the product through the installed instant messenger application.

Step 508, the two-dimension code authentication terminal parses the anti-counterfeiting two-dimension code to obtain the signature content and the digital signature corresponding to the signature content.

The two-dimension code authentication terminal may parse the acquired anti-counterfeiting two-dimension code to obtain the signature content and the digital signature corresponding to the signature content.

Step 509, the two-dimension code authentication terminal authenticates the digital signature with the signature content.

After obtaining the signature content and the digital signature corresponding to the signature content through parsing, the two-dimension code authentication terminal authenticates the digital signature with the signature content. Specifically, the step that the two-dimension code authentication terminal authenticates the digital signature with the signature content may comprise the following steps.

First, the two-dimension code authentication terminal decrypts the digital signature to obtain the decrypted message digest.

The digital signature in the anti-counterfeiting two-dimension code is a ciphertext signature encrypted by the private key, so that when authenticating the digital signature, the two-dimension code authentication terminal needs to decrypt the digital signature obtained through parsing so as to obtain the decrypted message digest.

Second, the two-dimension code authentication terminal generates the message digest of the signature content.

The two-dimension code authentication terminal may also generate the message digest of the signature content. Specifically, as the one-way function used by the two-dimension code generation terminal when generating the digital signature is open to the public, the two-dimension code authentication terminal generates the message digest of the signature content obtained through parsing according to the same one-way function as the one used when generating the digital signature.

Third, the two-dimension code authentication terminal detects whether the message digest obtained through decrypting matches the generated message digest.

After obtaining the decrypted message digest and generating the message digest of the signature content, the two-dimension code authentication terminal detects whether the message digest obtained through decrypting matches the generated message digest.

Fourth, when the detection result is a match, the digital signature passes the authentication.

If the detection result of the two-dimension code authentication terminal is a match, the two-dimension code authentication terminal may determine that the digital signature passes the authentication.

It should be noted that the steps 507 to 509 are similar to the steps 405 to 407 of the above embodiment, and reference is made to the above embodiment for technical details. Detailed description thereof will not be repeated here.

Step 510, if the digital signature passes the authentication, the two-dimension code authentication terminal sends the authentication message to the authentication server.

If the authentication result is that the digital signature passes the authentication of the two-dimension code authentication terminal, in order to further determine the information in the anti-counterfeiting two-dimension code, the two-dimension code authentication terminal may send the authentication message to the authentication server. In some embodiments, the authentication message includes the signature content, the digital signature or the combination thereof.

Step 511, the authentication server receives the authentication message sent by the two-dimension code authentication terminal.

Correspondingly, the authentication server may receive the authentication message sent by the two-dimension code authentication terminal.

Step 512, the authentication server counts the number of times that the product has been authenticated according to the received authentication message.

The authentication message is sent to the authentication server when the two-dimension code authentication terminal authenticates the authenticity of the product, and the authentication server will receive a plurality of authentication messages when the same product is authenticated for many times, so that the authentication server may calculate the number of the received authentication messages and take the number obtained through calculating as the number of times that the product has been authenticated.

Step 513, the authentication server detects whether the number of authentications obtained through counting reaches the maximum number of authentications.

After obtaining the number of times that the product has been authenticated through counting, the authentication server detects whether the number of authentications obtained through counting reaches the maximum number of authentications.

Step 514, if the detection result of the authentication server is that the number of authentications does not reach the maximum number of authentications, an authentication pass message is returned.

If the detection result of the authentication server is that the number of authentications does not reach the maximum number of authentications, the authentication server may return the authentication pass message.

And if the detection result of the authentication server is that the maximum number of authentications is reached, it means that the same product has been authenticated for many times. While in actual use, after learning the authenticity of the product by carrying out authentication, the user seldom authenticates the product again for many times, so that at this time it is very possible that the anti-counterfeiting two-dimension code of the product is misappropriated by law breakers. At this time, the authentication server may determine the product to be a counterfeit and returns an authentication failure message. Detailed description thereof will not be repeated here.

It should be noted that, after receiving the authentication message and when detecting that the authentication message is received for the first time, the authentication server may record the time at which the authentication message is received, namely, the time of the present authentication, and the current location of the two-dimension code authentication terminal (e.g., a GPS module in the two-dimension code authentication terminal reports its current location in the authentication message submitted to the authentication server). When receiving the authentication message again, the authentication server may return the recorded authentication time and/or location and prompt information used for prompting the user to input the reason for this authentication before returning the authentication pass message to the two-dimension code authentication terminal. After receiving the reason for authentication input by the user, the two-dimension code authentication terminal sends the received reason for authentication to the authentication server which saves the reason for received authentication and the time of this authentication. When receiving an authentication message of the same product again, the authentication server may return historical records of past authentication time, location and the reason for performing the authentication by different users along with the authentication pass message to the two-dimension code authentication terminal (as shown in FIGS. 3D and 4C), e.g., when the authentication timestamps and locations of different authentication messages associated with the same product satisfy a predefined product counterfeit pattern. Thus, the user may learn the historical information of the previous authentication performed to the product when determining the authenticity of the product. And when the anti-counterfeiting two-dimension code that the user requests for authentication is forged, the two-dimension code authentication terminal used by the user may receive the time and location of and the reason for the authentication performed to the anti-counterfeiting two-dimension code previously returned by the authentication server while receiving the authentication pass message returned by the authentication server. Thus, even though the two-dimension code authentication terminal may receive the authentication pass message, the user may determine the product corresponding to this anti-counterfeiting two-dimension code is a counterfeit when the product's authentication history suggests the opposite, thereby improving the accuracy of determining the authenticity of the product. As noted above, the authentication history information is an important source for preventing the anti-counterfeiting two-dimension code from being used on a counterfeit product because the authentication history may be inconsistent with, e.g., the current location of the product to be authenticated. Conversely, when the authentication timestamps and locations of different authentication messages associated with the same product does not satisfy any predefined product counterfeit pattern, the authentication server may only return the authentication pass message alone without any historical information as shown in FIGS. 3B, 3C, and 4B.

Step 515, when receiving the authentication pass message returned by the authentication server, the two-dimension code authentication terminal performs the step of determining whether the product is a product authenticated by the issuer.

The two-dimension code authentication terminal receives the authentication pass message returned by the authentication server and displays the product information provided by the issuer when receiving the authentication pass message. As noted above, the authentication history information may be provided to the two-dimension code authentication terminal to give the user additional information as to the authenticity of the product. In some embodiments, the authentication history information is only provided when certain condition is met. For example, the authentication history information may be displayed on the screen of the two-dimension code authentication terminal when the current location of the two-dimension code authentication terminal is different from the locations of the previous authentication messages for at least a predefined level (e.g., in different countries). Similarly, the authentication history information may be displayed on the screen of the two-dimension code authentication terminal when the timestamp of the current authentication message is different from the timestamp of the last authentication message for at least a predefined level (e.g., three months). In other words, the display of the authentication history information is to increase the awareness of the user of the two-dimension code authentication terminal that, although the product seems to be authentic, the user might run a risk of buying a counterfeit because the time and/or location gaps between different authentication messages may fit into a predefine pattern often found to be associated with a counterfeit.

If receiving the authentication failure message returned by the authentication server, the two-dimension code authentication terminal may determine the product to be a counterfeit.

It should be noted that in actual implementation, after obtaining the signature content and the digital signature corresponding to the signature content through parsing, the two-dimension code authentication terminal may not authenticate the digital signature obtained through parsing, but send the authentication message containing the signature content and the digital signature to the authentication server, and let the authentication server authenticate the authentication message through the authentication method of step 512 and step 513. This embodiment has no limit thereon. In some embodiments, the manner in which the authentication server authenticates the digital signature with the signature content is similar to the manner in which the two-dimension code authentication terminal authenticates the digital signature with the signature content. Reference is made to step 509 for specific technical details, and the embodiment gives no repeated description here.

Step 516, the two-dimension code authentication terminal acquires the product number and product purchase information of the product according to the signature content.

The two-dimension code authentication terminal may acquire the product number and product purchase information of the product according to the signature content obtained through parsing. Specifically, as the signature content may directly comprise the product number and product purchase information of the product or the link address of the product number and product purchase information of the product, the step that the two-dimension code authentication terminal acquires the product number and product purchase information of the product according to the signature content may comprise the following steps.

First, when the signature content includes the product number and the product purchase information of the product, the two-dimension code authentication terminal reads the product number and the product purchase information of the product.

Second, when the signature content includes the link address of the product number and product purchase information of the product, the two-dimension code authentication terminal sends an information acquisition request used for acquiring the product number and the product purchase information of the product to a storage server according to the link address and receives the product number and the product purchase information of the product returned from the storage server.

When the signature content includes the link address of the product number and product purchase information of the product, in order to acquire the product number and the product purchase information of the product, the two-dimension code authentication terminal sends the information acquisition request used for acquiring the product number and the product purchase information of the product to the storage server. In some embodiments, the information acquisition request may include the link address. After receiving the information acquisition request, the storage server may return the product number and the product purchase information stored in a page corresponding to the link address to the two-dimension code authentication terminal, and correspondingly, the two-dimension code authentication terminal receives the product number and the product purchase information returned from the storage server.

It should be noted that this step may be performed at any step after the step 504. In this embodiment, this step is performed in step 516, and the embodiment has no limit on the specific performing time.

Step 517, the two-dimension code authentication terminal displays the product number, the product purchase information and the information used for identifying the product as a product authenticated by the issuer.

After acquiring the product number and the product purchase information, the two-dimension code authentication terminal may display the product number, the product purchase information and the information used for identifying the product as a product authenticated by the issuer.

In actual implementation, the two-dimension code authentication terminal may also display the selection option used for agreeing to purchase the product, and the user may request to purchase the product by triggering the selection information. Referring specifically to FIG. 5B, the embodiment has no limit thereon.

Step 518, the two-dimension code authentication terminal receives a trigger signal used for agreeing to purchase the product.

After determining the product to be a product authenticated by the issuer according to the content displayed by the two-dimension code authentication terminal, the user may choose to purchase the product. At this time, the user may initiate the trigger signal used for purchasing the product, and correspondingly, the two-dimension code authentication terminal may receive the trigger signal used for agreeing to purchase the product.

Step 519, after receiving the trigger signal, the two-dimension code authentication terminal completes the product purchase process interactively with a redemption server according to the product number and the product purchase information of the product.

After receiving the trigger signal, the two-dimension code authentication terminal may complete the product purchase process interactively with the redemption server according to the product number and the product purchase information of the product.

It should be noted that the steps 516 to 519 are similar to the steps 409 to 412 of the above embodiment, and reference is made to the above embodiment for technical details. Detailed description thereof will not be repeated here.

In conclusion, according to the product anti-counterfeiting method provided by this embodiment, the signature content related to the product is digitally signed, and the anti-counterfeiting two-dimension code containing the signature content and the digital signature is generated. Thus when trying to determine the authenticity of the product, the user displays the product information provided by the issuer by acquiring the anti-counterfeiting two-dimension code corresponding to the product, parsing the anti-counterfeiting two-dimension code to obtain the signature content and the digital signature thereof, authenticating the digital signature according to the signature content and passing the authentication with the digital signature. Therefore, the problem in the conventional approaches that the operation for determining the authenticity of the product is very complicated to the user is solved. The effect that the user can learn the authenticity of the product conveniently just by scanning the anti-counterfeiting two-dimension code corresponding to the product is achieved.

According to this embodiment, the signature content is provided with the product number and the product purchase information, and the two-dimension code authentication terminal may complete the product purchase process interactively with the redemption server through the product number and the product purchase information while determining the authenticity of the product, thereby realizing the combination of authenticity determination and product purchase and greatly enhancing the user convenience.

In this embodiment, the two-dimension code authentication terminal sends the authentication message to the authentication server for further authentication before determining the product to be a product authenticated by the issuer and thus displays the product information provided by the issuer only when the number of authentications that the authentication message is subjected to does not reach the maximum number of authentications. Therefore, the problem that a counterfeit will be misjudged as the product authenticated by the issuer when the anti-counterfeiting two-dimension code of the product is misappropriated is avoided, and the accuracy of determining the authenticity of the product is improved.

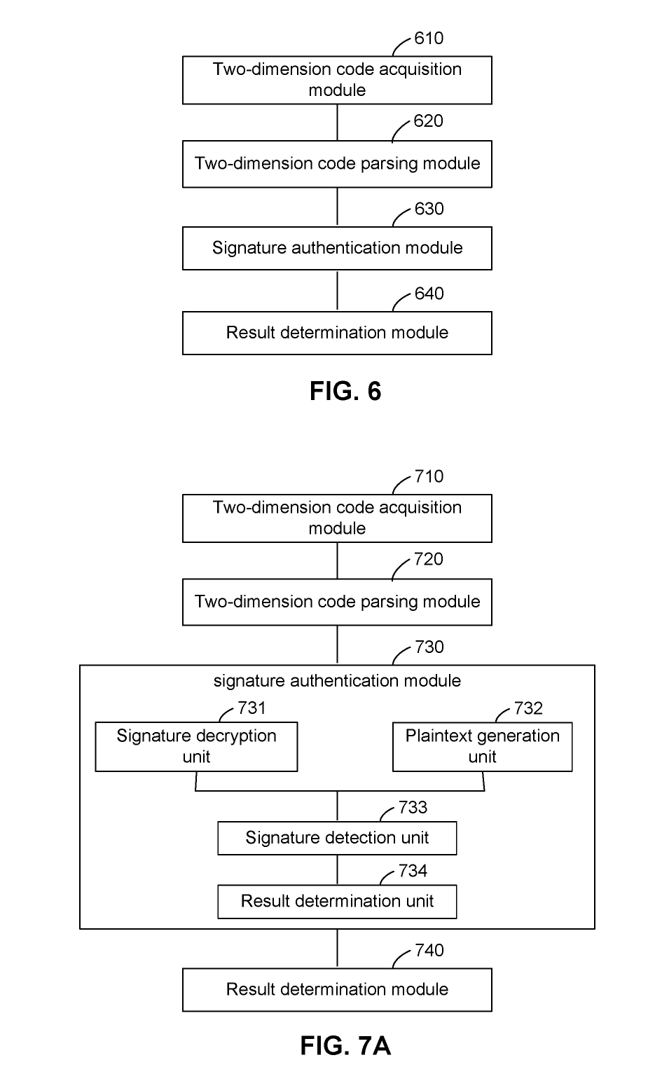

As shown in FIG. 6, there is shown a structural block diagram of a product anti-counterfeiting apparatus according to an embodiment of the present application. The product anti-counterfeiting apparatus may be implemented by software, hardware or the combination thereof as the whole or part of the two-dimension code authentication terminal. The product anti-counterfeiting apparatus comprises a two-dimension code acquisition module 610, a two-dimension code parsing module 620, a signature authentication module 630 and a result determination module 640.

The two-dimension code acquisition module 610 is used for acquiring the anti-counterfeiting two-dimension code corresponding to the product to be authenticated.

The two-dimension code parsing module 620 is used for parsing the anti-counterfeiting two-dimension code acquired by the two-dimension code acquisition module 610 to obtain the signature content and the digital signature corresponding to the signature content, wherein the digital signature is used to authenticate whether the product is a product authenticated by the issuer.

The signature authentication module 630 is used for authenticating the digital signature according to the signature content.

The result determination module 640 is used for determining the product to be a product authenticated by the issuer when the digital signature passes the authentication of the signature authentication module 630.

In conclusion, with the product anti-counterfeiting apparatus provided by this embodiment, by acquiring the signature content associated with the product, generating the digital signature of the signature content and generating the anti-counterfeiting two-dimension code containing the signature content and the digital signature, the user who wants learn the authenticity of a product may determine the authenticity of the product directly by scanning the anti-counterfeiting two-dimension code of the product. Therefore, the problem in the conventional approaches that the operation for determining the authenticity of the product is very complicated to the user is solved. The effect that user can learn the authenticity of the product conveniently just by scanning an anti-counterfeiting two-dimension code corresponding to the product is achieved.

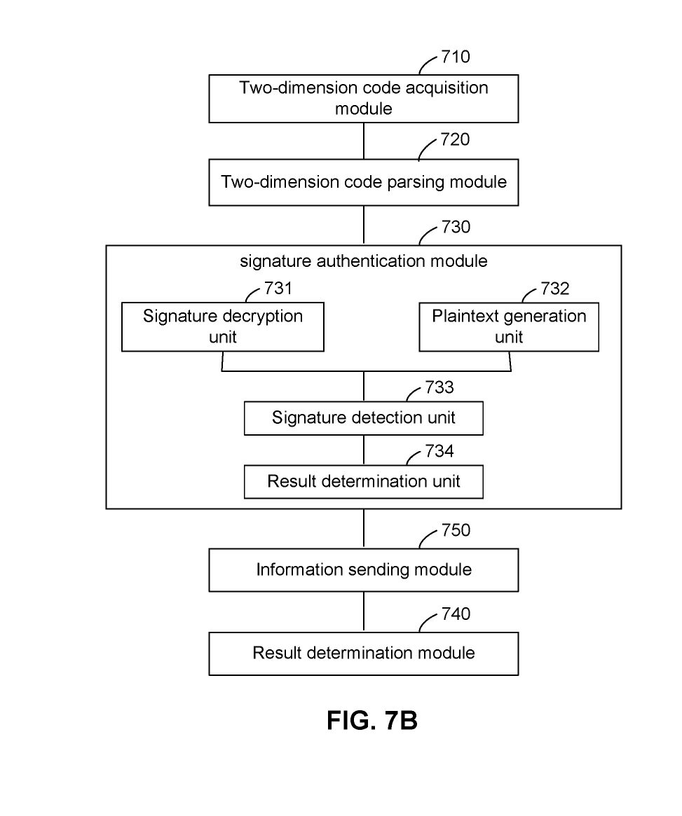

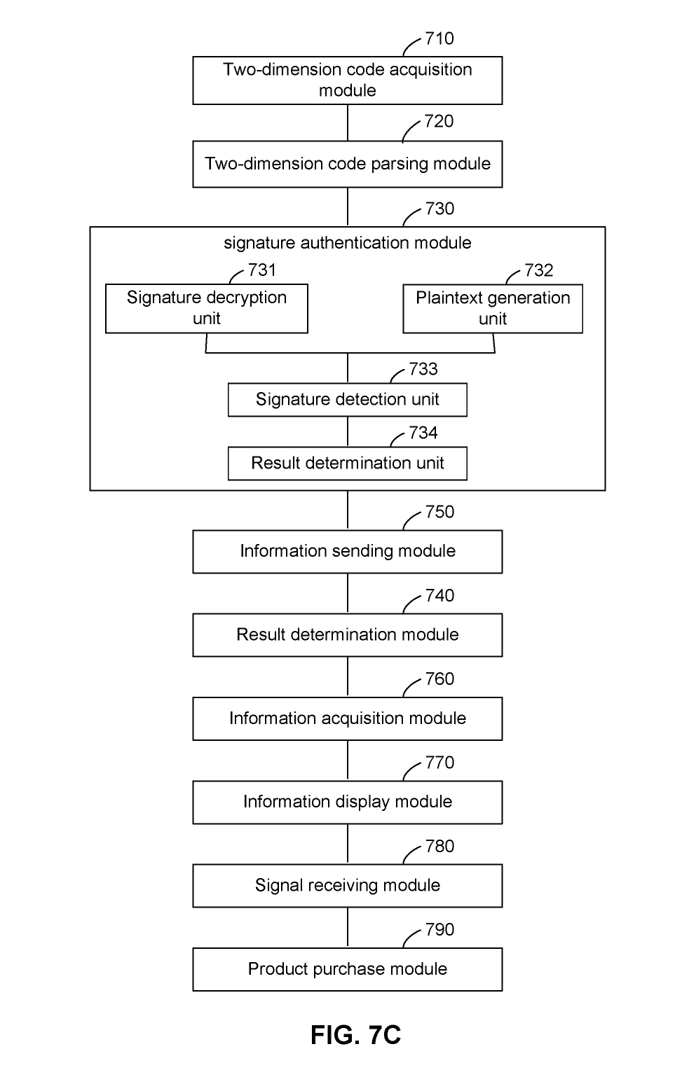

As shown in FIG. 7A, there is shown a structural block diagram of a product anti-counterfeiting apparatus according to another embodiment of the present application. The product anti-counterfeiting apparatus may be implemented by software, hardware or the combination thereof as the whole or part of the two-dimension code authentication terminal. The product anti-counterfeiting apparatus comprises a two-dimension code acquisition module 710, a two-dimension code parsing module 720, a signature authentication module 730 and a result determination module 740.

The two-dimension code acquisition module 710 is used for acquiring the anti-counterfeiting two-dimension code corresponding to the product to be authenticated.

The two-dimension code parsing module 720 is used for parsing the anti-counterfeiting two-dimension code acquired by the two-dimension code acquisition module 710 to obtain the signature content and the digital signature corresponding to the signature content, wherein the digital signature is used to authenticate whether the product is a product authenticated by the issuer.

The signature authentication module 730 is used for authenticating the digital signature according to the signature content.

The result determination module 740 is used for determining the product to be a product authenticated by the issuer when the digital signature passes the authentication of the signature authentication module 730.

In a first possible implementation manner of this embodiment, the signature authentication module 730 comprises: a signature decryption unit 731 for decrypting the digital signature to obtain a decrypted message digest; a plaintext generation unit 732 for generating the message digest of the signature content; a signature detection unit 733 for detecting whether the message digest obtained through decrypting by the signature decryption unit 731 matches the message digest generated by the plaintext generation unit 732; and a result determination unit 734 for determining that the digital signature passes the authentication when the detection result of the signature detection unit 733 is a match.

As shown in FIG. 7B, in a second possible manner of implementation of this embodiment, the apparatus further comprises: an information sending module 750 for sending the authentication message to the authentication server, wherein the authentication message includes the signature content and/or the digital signature such that the authentication server counts the number of times that the product has been authenticated according to the received authentication message and detects whether the number of authentications reaches a maximum number of authentications. If the detection result is that maximum number of authentications is not reached, the authentication pass message is returned.

The result determination module 740 is also used for performing the step of determining the product to be a product authenticated by the issuer when receiving the authentication pass message returned by the authentication server.

As shown in FIG. 7C, in a third possible manner of implementation of this embodiment, the apparatus further comprises: an information acquisition module 760 for acquiring the product number and the product purchase information of the product according to the signature content; an information display module 770 for displaying the product number, the product purchase information and the information used for identifying the product as a product authenticated by the issuer; a signal receiving module 780 for receiving the trigger signal used for agreeing to purchase the product; and a product purchase module 790 for completing the product purchase process interactively with a redemption server according to the product number and the product purchase information of the product after the signal receiving module 780 receives the trigger signal.

In a fourth possible manner of implementation of this embodiment, the information acquisition module 760 comprises: a first acquisition unit 761 or a second acquisition unit 762; wherein the first acquisition unit 761 is used for reading the product number and the product purchase information of the product when the signature content includes the product number and the product purchase information of the product; and the second acquisition unit 762 is used for sending an information acquisition request used for acquiring the product number and the product purchase information according to the link address to a storage server and receiving the product number and the product purchase information returned by the storage server, when the signature content includes the link address of the product number and the product purchase information of the product.

In conclusion, with the product anti-counterfeiting apparatus provided by this embodiment, by acquiring the signature content associated with the product, generating the digital signature of the signature content and generating the anti-counterfeiting two-dimension code containing the signature content and the digital signature, the user who wants learn the authenticity of a product may determine the authenticity of the product directly by scanning the anti-counterfeiting two-dimension code of the product. Therefore, the problem in the conventional approaches that the operation for determining the authenticity of the product is very complicated to the user is solved. The effect that the user can learn the authenticity of the product conveniently just by scanning the anti-counterfeiting two-dimension code corresponding to the product is achieved.

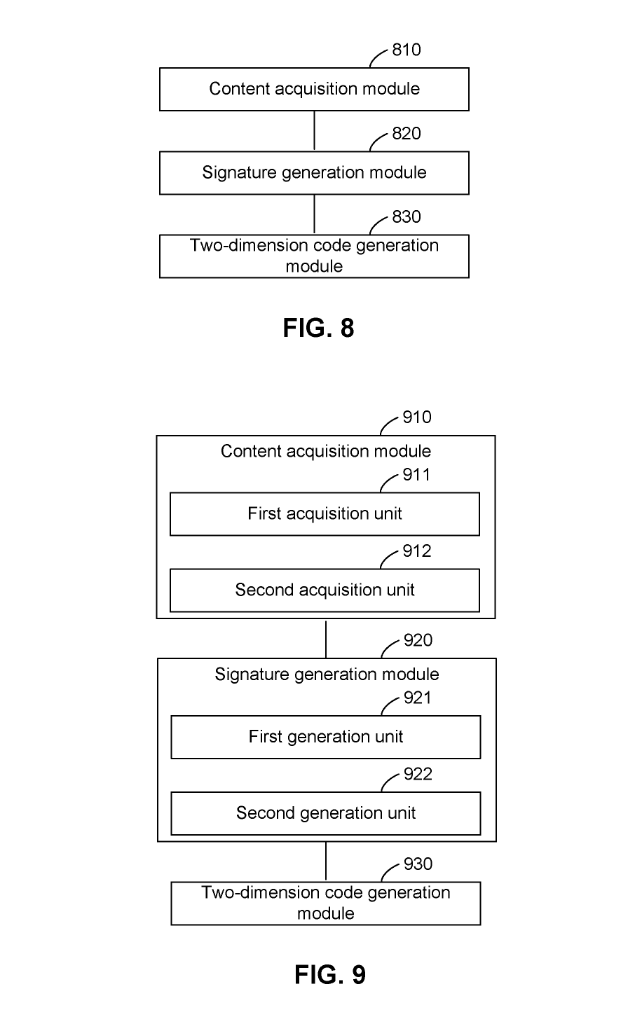

As shown in FIG. 8, there is shown a structural block diagram of a product anti-counterfeiting apparatus according to an embodiment of the present application. The product anti-counterfeiting apparatus may be implemented by software, hardware or the combination thereof as the whole or part of the two-dimension code authentication terminal. The product anti-counterfeiting apparatus comprises a content acquisition module 810, a signature generation module 820 and a two-dimension code generation module 830.

The content acquisition module 810 is used for acquiring the signature content related to the product.

The signature generation module 820 is used for generating the digital signature of the signature content acquired by the content acquisition module 810 with a digital signature algorithm, wherein the digital signature is used to authenticate whether the product is a product authenticated by the issuer.

The two-dimension code generation module 830 is used for generating the anti-counterfeiting two-dimension code containing the signature content acquired by the content acquisition module 810 and the digital signature generated by the signature generation module 820.

In conclusion, with the product anti-counterfeiting apparatus provided by this embodiment, the signature content related to the product is digitally signed, and the anti-counterfeiting two-dimension code containing the signature content and the digital signature is generated. Thus when trying to determine the authenticity of the product, the user displays the product information provided by the issuer by acquiring the anti-counterfeiting two-dimension code corresponding to the product, parsing the anti-counterfeiting two-dimension code to obtain the signature content and the digital signature thereof, authenticating the digital signature according to the signature content and passing the authentication with the digital signature. Therefore, the problem in the conventional approaches that the operation for determining the authenticity of the product is very complicated to the user is solved. The effect that the user can learn the authenticity of the product conveniently just by scanning the anti-counterfeiting two-dimension code corresponding to the product is achieved.

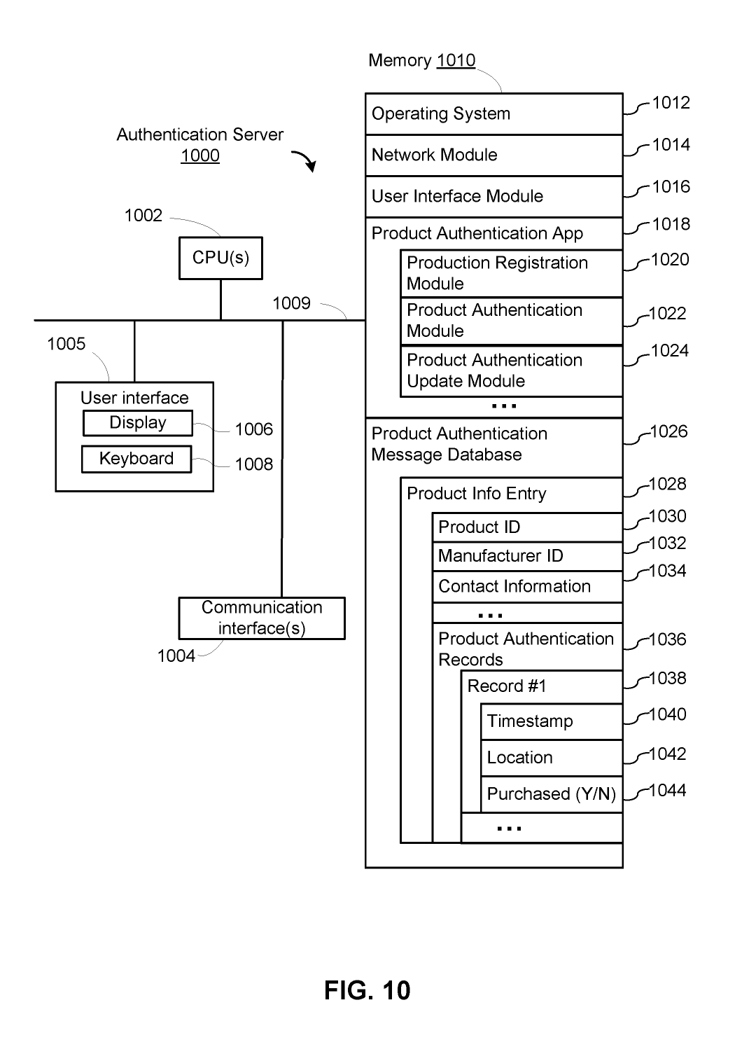

As shown in FIG. 9, there is shown a structural block diagram of a product anti-counterfeiting apparatus according to another embodiment of the present application. The product anti-counterfeiting apparatus may be implemented by software, hardware or the combination thereof as the whole or part of the two-dimension code authentication terminal. The product anti-counterfeiting apparatus comprises a content acquisition module 910, a signature generation module 820 and a two-dimension code generation module 930.

The content acquisition module 910 is used for acquiring the signature content related to the product.

The signature generation module 920 is used for generating the digital signature of the signature content acquired by the content acquisition module 910 with a digital signature algorithm, wherein the digital signature is used to authenticate whether the product is a product authenticated by the issuer.

The two-dimension code generation module 930 is used for generating the anti-counterfeiting two-dimension code containing the signature content acquired by the content acquisition module 910 and the digital signature generated by the signature generation module 920.

In a first possible manner of implementation of this embodiment, when the two-dimension code authentication terminal needs to authenticate whether the product is a product authenticated by the issuer, and the two-dimension code authentication terminal is not connected with an authentication server, the signature content and the digital signature are used by the two-dimension code authentication terminal to authenticate the digital signature according to the signature content and determines the product to be a product authenticated by the issuer when the digital signature passes the authentication; and when the two-dimension code authentication terminal needs to authenticate whether the product is a product authenticated by the issuer, and the two-dimension code authentication terminal is not connected with an authentication server, the signature content and the digital signature are used by the two-dimension code authentication terminal to authenticate the digital signature according to the signature content and by the authentication server to count the number of times that the product has been authenticated according to the authentication message and detects whether the number of authentications reaches a maximum number of authentications. The authentication message includes the signature content and/or the digital signature. Thus, when the digital signature passes the authentication of the two-dimension code authentication terminal, and the detection result of the authentication server is that the number of authentications does not reach the maximum number of authentications, the two-dimension code authentication terminal displays the product information provided by the issuer.

In a second possible manner of implementation of this embodiment, the signature generation module 920 comprises: a first generation unit 921 for generating the message digest of the signature content based on the digital signature algorithm and the signature content; and a second generation unit 922 for encrypting the message digest generated by the first generation unit 921 to obtain the digital signature.

In a third possible manner of implementation of this embodiment, the content acquisition module 910 comprises: a first acquisition unit 911 or a second acquisition unit 912; wherein the first acquisition unit 911 is used for acquiring the product number and the product purchase information of the product and taking the product number and the product purchase information acquired as the signature content; and the second acquisition unit 912 is used for acquiring the link address of the product number and the product purchase information of the product and taking the link address acquired as the signature content.

In conclusion, with the product anti-counterfeiting apparatus provided by this embodiment, the signature content related to the product is digitally signed, and the anti-counterfeiting two-dimension code containing the signature content and the digital signature is generated. Thus when trying to determine the authenticity of the product, the user displays the product information provided by the issuer by acquiring the anti-counterfeiting two-dimension code corresponding to the product, parsing the anti-counterfeiting two-dimension code to obtain the signature content and the digital signature thereof, authenticating the digital signature according to the signature content and passing the authentication with the digital signature. Therefore, the problem in the conventional approaches that the operation for determining the authenticity of the product is very complicated to the user is solved. The effect that user can learn the authenticity of the product conveniently just by scanning an anti-counterfeiting two-dimension code corresponding to the product is achieved.

It should be noted that the two-dimension code authentication terminal and the two-dimension code generation terminal may constitute an anti-counterfeiting authentication system, and the two-dimension code authentication terminal may comprise the product anti-counterfeiting apparatus shown in FIG. 6 or 7A-7C. The two-dimension code generation terminal may comprise the product anti-counterfeiting apparatus shown in FIGS. 8 and 9.

It should be noted that when the product is subjected to anti-counterfeit carried out with the product anti-counterfeiting apparatus provided by the above embodiment, only the division of the functional modules will be illustrated. In practical application, the function may be distributed to be accomplished by different functional modules as required, that is, the internal structure of the equipment is divided into different functional modules to accomplish all or part of the functions mentioned above. Moreover, the embodiments of product anti-counterfeiting apparatus and method provided by the above embodiment are covered by the same conception. The specific implementation thereof is detailed in the embodiment of the method, and detailed description thereof will not be repeated herein.

FIG. 10 is a structural diagram of components of an authentication server according to an embodiment of the present application. The exemplary authentication server 1000 typically includes one or more processing units (CPU's) 1002, one or more network or communications interfaces 1004, memory 1010, and one or more communication buses 1009 for interconnecting these components and with other computer systems (e.g., the two-dimension code generation terminal and the two-dimension code authentication terminal). The communication buses 1009 may include circuitry (sometimes called a chipset) that interconnects and controls communications between system components. The authentication server 1000 may optionally include a user interface 1005, for instance, a display 1006, and a keyboard 1008. Memory 1010 may include high speed random access memory and may also include non-transitory computer readable medium, such as one or more magnetic disk storage devices. Memory 1010 may include mass storage that is remotely located from the CPU's 1002. In some embodiments, memory 1010 stores the following programs, modules and data structures, or a subset or superset thereof:
an operating system 1012 that includes procedures for handling various basic system services and for performing hardware dependent tasks;
a network module 1014 that is used for connecting the authentication server 1000 to the terminals and other computer systems (e.g., PC, tablet or smartphone) via one or more communication networks (wired or wireless), such as the Internet, other wide area networks, local area networks, metropolitan area networks, and so on;
a user interface module 1016 configured to receive user inputs through the user interface 1005;
a product authentication application 1018, the product authentication application 1018 further including:
   a product registration module 1020 for receiving and storing signature content and/or digital signature associated with a product from the two-dimension code generation terminal as described above in connection with FIG. 5;
   a product authentication module 1022 for determining the authenticity of a product based on the information in the anti-counterfeiting two-dimension code provided by the two-dimension code authentication terminal as described above in connection with FIG. 5; and
   a product authentication update module 1024 for keeping track the historical information authenticating a product as described above in connection with FIG. 5.
a product authentication message database 1026 for managing the product authentication message from different terminals as described above in connection with FIG. 5. For example, a product information entry 1028 further includes a product identifier 1030 for uniquely identifying a particular product, a manufacturer identifier 1032 for uniquely identifying a manufacturer of the product, contact information 1034 of the manufacturer, one or more product authentication records 1036, etc., each record 1038 further including a timestamp 1040 corresponding to when the product authentication message was received from a particular terminal, a location 1042 of the terminal, and optionally a binary parameter 1044 indicating whether the product was purchased or not right after the authentication inquiry. In some embodiments, the product identifier 1030, the manufacturer identifier 1032, contact information 1034, and other product-related information (e.g., manufacturing date, expiration date, etc.) are derived from the signature content and/or digital signature of the product provided by the two-dimension code generation terminal. Note that the identity of the terminal initiating the inquiry is not stored in the database for protecting the privacy of the user of the terminal.

It is understood by those ordinary skilled in the art that the implementation of all or part of the process of the above-described embodiment of the method can be accomplished by hardware or relevant hardware under instruction of a program, wherein the program may be stored in a computer readable storage medium. The above-mentioned storage medium may be a read only memory (ROM), a magnetic disk or an optical disk, etc.

The present application has been described with reference to preferred embodiments which are not intended to limit the invention, and any modification, equivalent, improvement and the like made within the spirit and principle of the invention should fall in the protection scope thereof.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

Although the terms first, second, etc. may be used herein to describe various elements, these elements should not be limited by these terms. These terms are only used to distinguish one element from another. For example, first ranking criteria could be termed second ranking criteria, and, similarly, second ranking criteria could be termed first ranking criteria, without departing from the scope of the present application. First ranking criteria and second ranking criteria are both ranking criteria, but they are not the same ranking criteria.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain principles of the invention and its practical applications, to thereby enable others skilled in the art to best utilize the invention and various implementations with various modifications as are suited to the particular use contemplated. Implementations include alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the implementations.

What is claimed is:

1. A computer-implemented method for product anti-counterfeiting, the method comprising:
at a computer server having one or more processors and memory for storing one or more program modules to be executed by the one or more processors:
receiving a product authentication message from a client terminal;
determining a total number of times that the product has been authenticated based, at least in part, on the product authentication message;
when the total number of times is less than a predefined threshold level:
generating a new product authentication record for the product from the product authentication message;
identifying one or more existing product authentication records generated from past product authentication messages associated with the product; and
returning information derived from at least one existing product authentication record to the client terminal based on a comparison between the new product authentication record and the at least one existing product authentication record.

2. The method of claim 1, wherein the product authentication message is generated by the client terminal performing the following steps:
scanning an anti-counterfeiting two-dimension code displayed on the product;
obtaining a digital signature and signature content from the anti-counterfeiting two-dimension code;
obtaining a decrypted message digest from the digital signature and generating a new message digest from the signature content, respectively; and
generating the product authentication message using the digital signature and the signature content when the decrypted message digest matches the new message digest.

3. The method of claim 1, further comprising:
before receiving the product authentication message from the client terminal:
receiving signature content and a digital signature associated with the product from a second client device; and
generating a product information entry using the signature content and the digital signature, the product information entry including a product identifier and a manufacturer identifier, wherein the product authentication records are associated with the product information entry.

4. The method of claim 1, further comprising:
when the total number of times reaches or exceeds the predefined threshold level:
updating a product information entry associated with the product to indicate that the product is deemed to be a counterfeit; and
sending an authentication failure message to the client device.

5. The method of claim 1, wherein each product authentication record includes a timestamp when a corresponding product authentication message was generated and a location where the corresponding product authentication message was generated.

6. The method of claim 5, further comprising:
when the total number of times is less than the predefined threshold level:
comparing the timestamp and location of the new product authentication record with the timestamp and location of at least one of the existing product authentication records;
when differences between the timestamps and locations of the new and existing product authentication records satisfy a predefined product counterfeit pattern, sending an authentication pass message to the client device, the authentication pass message including information derived from at least one of the existing product authentication records that satisfies the predefined product counterfeit pattern; and
when the differences between the timestamps and locations of the new and existing product authentication records satisfy the predefined product counterfeit pattern, sending the authentication pass message to the client device, the authentication pass message not including information derived from any existing product authentication record.

7. A computer-implemented method for product anti-counterfeiting using a mobile device, the method comprising:
at the mobile device having one or more processors and memory for storing one or more program modules to be executed by the one or more processors:
acquiring an anti-counterfeiting two-dimension code corresponding to a product to be authenticated;
parsing the anti-counterfeiting two-dimension code to obtain signature content and a digital signature corresponding to the signature content;
authenticating the digital signature with the signature content; and
determining the product to be a product authenticated by its issuer when the digital signature and the signature content pass the authentication.

8. The method of claim 7, wherein the step of authenticating the digital signature with the signature content further includes:
decrypting the digital signature to obtain a decrypted message digest;
generating a new message digest from the signature content; and
authenticating the digital signature with the signature content when the decrypted message digest matches the newly-generated message digest.

9. The method of claim 7, further comprising:
before determining the product to be a product authenticated by its issuer:
sending a new product authentication message to an authentication server, wherein the authentication server is configured to determine the authenticity of the product, at least in part, based the new product authentication message;
receiving an authentication pass message from the authentication server, wherein the authentication pass message includes information derived from at least one earlier product authentication message that, together with the new product authentication message, satisfies a predefined product counterfeit pattern; and
displaying the information derived from the at least one earlier product authentication message along with the authentication pass message.

10. The method of claim 7, further comprising:
before determining the product to be a product authenticated by its issuer:
sending a new product authentication message to an authentication server, wherein the authentication server is configured to generate an authentication failure message when a total number of times that the product has been authenticated based, at least in part, on the new product authentication message reaches a predefined threshold level;
receiving the authentication failure message from the authentication server, wherein the authentication pass message includes information derived from at least one earlier product authentication message that, together with the new product authentication message, satisfies a predefined product counterfeit pattern; and
displaying the authentication failure message along with a result of authenticating the digital signature with the signature content.

11. An authentication server comprising:
one or more processors;
memory; and
one or more program modules stored in the memory and to be executed by the one or more processors, the one or more program modules further including instructions for:
receiving a product authentication message from a client terminal;
determining a total number of times that the product has been authenticated based, at least in part, on the product authentication message;
when the total number of times is less than a predefined threshold level:
generating a new product authentication record for the product from the product authentication message;
identifying one or more existing product authentication records generated from past product authentication messages associated with the product; and
returning information derived from at least one existing product authentication record to the client terminal based on a comparison between the new product authentication record and the at least one existing product authentication record.

12. The authentication server of claim 11, wherein the product authentication message is generated by the client terminal performing the following steps:
scanning an anti-counterfeiting two-dimension code displayed on the product;
obtaining a digital signature and signature content from the anti-counterfeiting two-dimension code;
obtaining a decrypted message digest from the digital signature and generating a new message digest from the signature content, respectively; and
generating the product authentication message using the digital signature and the signature content when the decrypted message digest matches the new message digest.

13. The authentication server of claim 11, wherein the one or more program modules further include instructions for:
before receiving the product authentication message from the client terminal:
receiving signature content and a digital signature associated with the product from a second client device; and
generating a product information entry using the signature content and the digital signature, the product information entry including a product identifier and a manufacturer identifier, wherein the product authentication records are associated with the product information entry.

14. The authentication server of claim 11, wherein the one or more program modules further include instructions for:
when the total number of times reaches or exceeds the predefined threshold level:
updating a product information entry associated with the product to indicate that the product is deemed to be a counterfeit; and
sending an authentication failure message to the client device.

15. The authentication server of claim 11, wherein each product authentication record includes a timestamp when a corresponding product authentication message was generated and a location where the corresponding product authentication message was generated.

16. The authentication server of claim 15, wherein the one or more program modules further include instructions for:
when the total number of times is less than the predefined threshold level:
comparing the timestamp and location of the new product authentication record with the timestamp and location of at least one of the existing product authentication records;
when differences between the timestamps and locations of the new and existing product authentication records satisfy a predefined product counterfeit pattern, sending an authentication pass message to the client device, the authentication pass message including information derived from at least one of the existing product authentication records that satisfies the predefined product counterfeit pattern; and
when the differences between the timestamps and locations of the new and existing product authentication records satisfy the predefined product counterfeit pattern, sending the authentication pass message to the client device, the authentication pass message not including information derived from any existing product authentication record.

17. A mobile device, comprising:
one or more processors;
memory; and
one or more program modules stored in the memory and to be executed by the one or more processors, the one or more program modules further including instructions for:
acquiring an anti-counterfeiting two-dimension code corresponding to a product to be authenticated;
parsing the anti-counterfeiting two-dimension code to obtain signature content and a digital signature corresponding to the signature content;
authenticating the digital signature with the signature content; and
determining the product to be a product authenticated by its issuer when the digital signature and the signature content pass the authentication.

18. The mobile device of claim 17, wherein the instruction for authenticating the digital signature with the signature content further includes instructions for:
decrypting the digital signature to obtain a decrypted message digest;
generating a new message digest from the signature content; and
authenticating the digital signature with the signature content when the decrypted message digest matches the newly-generated message digest.

19. The mobile device of claim 17, wherein the one or more program modules further include instructions for:
before determining the product to be a product authenticated by its issuer:
sending a new product authentication message to an authentication server, wherein the authentication server is configured to determine the authenticity of the product, at least in part, based the new product authentication message;
receiving an authentication pass message from the authentication server, wherein the authentication pass message includes information derived from at least one earlier product authentication message that, together with the new product authentication message, satisfies a predefined product counterfeit pattern; and
displaying the information derived from the at least one earlier product authentication message along with the authentication pass message.

20. The mobile device of claim 17, wherein the one or more program modules further include instructions for:
before determining the product to be a product authenticated by its issuer:
sending a new product authentication message to an authentication server, wherein the authentication server is configured to generate an authentication failure message when a total number of times that the product has been authenticated based, at least in part, on the new product authentication message reaches a predefined threshold level;
receiving the authentication failure message from the authentication server, wherein the authentication pass message includes information derived from at least one earlier product authentication message that, together with the new product authentication message, satisfies a predefined product counterfeit pattern; and
displaying the authentication failure message along with a result of authenticating the digital signature with the signature content.
